(19) United States
(12) Patent Application Publication
(10) Pub. No.: US 2008/0071000 A1
(43) Pub. Date: Mar. 20, 2008

(54) POLY(ARYLENE ETHER) COMPOSITION AND ARTICLE

(76) Inventors: Christina Louise Braidwood, Niskayuna, NY (US); Hua Guo, Selkirk, NY (US); Edward N. Peters, Lenox, MA (US)

Correspondence Address: CANTOR COLBURN LLP - SABIC (NORYL), 20 Church Street, 22nd Floor, Hartford, CT, 06103, US

(21) Appl. No.: 11/532,164

(22) Filed: Sep. 15, 2006

(51) Int. Cl. C08J 9/00

(52) U.S. Cl. 521/134; 528/86

(57) ABSTRACT

A cured composition is prepared by curing a composition that includes an alkyl styrene and a low molecular weight, bifunctional poly(arylene ether). The curable composition can be prepared and processed at substantially lower temperatures than prior art poly(arylene ether) thermosets. The cured composition exhibits an improved balance of heat resistance, impact strength, and dielectric properties, making it particularly suitable for the fabrication of electronic components.

### BACKGROUND OF THE INVENTION

Circuit boards are used in virtually every electronic device today from computer equipment to cell phones to electronic toys and even watches. As the use of circuit boards has increased, their performance requirements have also increased including better toughness, higher temperature resistance, and better signal-to-noise ratios.

Circuit boards are commonly manufactured by coating a cloth made of glass fibers with a liquid resin that wets the cloth. Chemicals called hardeners or curing agents are added to the liquid resin to begin chemical reactions that convert the liquid resin into a solid. This chemical conversion is often referred to as curing.

The glass cloth that contains the liquid resin is often partially cured and is referred to a “prepreg” describing the preimpregnation of the glass cloth with the liquid resin. During the manufacture of circuit boards, several layers of prepreg are often combined under pressure and allowed to fully cure into a solid circuit board.

Vinyl resins are one example of commonly used curable liquid resins in such processes. However, the cured vinyl resins are generally too brittle and have insufficient heat resistance to be used in some circuit board applications. The addition of various poly(arylene ether)s, for example poly(arylene ether)s terminally functionalized with polymerizable carbon-carbon double bonds, into vinyl resins has been proposed as a way to reduce their brittleness in circuit boards. For example, U.S. Pat. No. 6,352,782 to Yeager et al. describes a resin composition comprising (1) a reactively end-capped poly(phenylene ether), and (2) a curable unsaturated monomer composition. As another example, U.S. Pat. No. 6,627,704 to Yeager et al. describes a thermosetting composition comprising a capped poly(arylene ether), an alkenyl aromatic monomer, and an acryloyl monomer. In both of these patents, preparation of the curable compositions in the absence of added solvent requires heating to a temperature of about 80 to 140° C. See U.S. Pat. No. 6,352,782 at col. 16, lines 42-45; and U.S. Pat. No. 6,627,704 at col. 28, lines 60-64.

Although significant improvements have been made in curable resins, there is an ongoing need for materials that exhibit a better combination of improved heat resistance, increased toughness, and better signal-to-noise ratios (that is, improved electrical properties) after curing as well compositions that can be prepared in the absence of solvent at lower temperatures.

### BRIEF DESCRIPTION OF THE INVENTION

The above-described and other drawbacks are alleviated by a cured composition, comprising a reaction product obtained on curing a curable composition, wherein the curable composition comprises: a bifunctional poly(arylene ether) having an intrinsic viscosity of about 0.03 to about 0.2 deciliter per gram, measured in chloroform at 25° C.; and an alkyl styrene having the structure

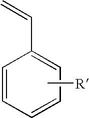

wherein R′ is C₁-C₆ primary or tertiary alkyl; wherein the bifunctional poly(arylene ether) has a solubility in the alkyl styrene of at least 10 weight percent for at least seven days at 23° C., wherein the weight percent is based on the total weight of the bifunctional poly(arylene ether) and the alkyl styrene; and wherein the curable composition has a viscosity less than or equal to 2000 centipoise at 23° C.

Another embodiment is a cured composition, consisting of the reaction product obtained on curing a curable composition consisting of: a bifunctional poly(arylene ether) having an intrinsic viscosity of about 0.03 to about 0.2 deciliter per gram, measured in chloroform at 25° C.; an alkyl styrene having the structure

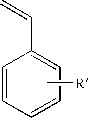

wherein R′ is C₁-C₆ primary or tertiary alkyl; optionally, a filler; optionally, a trivinylbenzenes, triallylbenzenes, divinyl phthalates, diallyl phthalates, triallyl mesate, triallyl mesitate, ethoxylated bisphenol A dimethacrylates, and mixtures thereof; optionally, a curing initiator, a curing inhibitor, or a combination thereof; and optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof; wherein the bifunctional poly(arylene ether) has a solubility in the alkyl styrene of at least 10 weight percent for at least seven days at 23° C.; and wherein the curable composition in the absence of optional filler has a viscosity less than or equal to 2000 centipoise at 23° C.

Another embodiment is a cured composition, comprising a reaction product obtained on curing a curable composition, wherein the curable composition comprises: about 30 to about 90 parts by weight of a bifunctional poly(arylene ether) having an intrinsic viscosity of about 0.03 to about 0.2 deciliter per gram, measured in chloroform at 25° C., wherein the bifunctional poly(arylene ether) has the structure

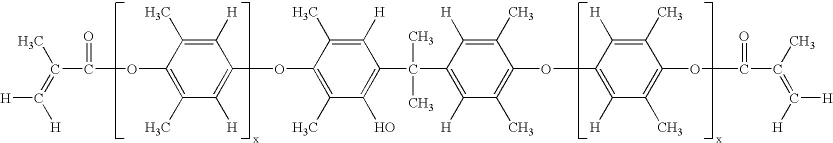

wherein each occurrence of x is independently 1 to about 20; and about 10 to about 70 parts by weight of an alkyl styrene selected from the group consisting of 2-methylstyrene, 4-methylstyrene, 2-tert-butylstyrene, 4-tert-butylstyrene, and mixtures thereof; wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene; wherein the curable composition has a viscosity of about 50 to about 600 centipoise at 23° C.; and wherein all parts by weight are based on 100 parts by weight total of the bifunctional poly(arylene ether) and the alkyl styrene.

Another embodiment is a cured composition, consisting of the reaction product obtained on curing a curable composition consisting of: about 30 to about 90 parts by weight of a bifunctional poly(arylene ether) having an intrinsic viscosity of about 0.03 to about 0.2 deciliter per gram, measured in chloroform at 25° C., wherein the bifunctional poly(arylene ether) has the structure

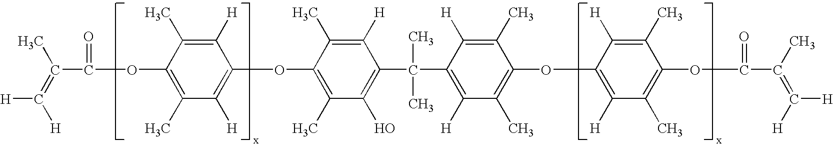

wherein each occurrence of x is independently 1 to about 20; and about 10 to about 70 parts by weight of an alkyl styrene selected from the group consisting of 2-methylstyrene, 4-methylstyrene, 2-tert-butylstyrene, 4-tert-butylstyrene, and mixtures thereof; optionally, about 2 to about 95 weight percent of a filler, based on the total weight of the composition; optionally, about 4 to about 16 parts by weight of divinylbenzene; optionally, a curing initiator, a curing inhibitor, or a combination thereof; and optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof; wherein all parts by weight are based on 100 parts by weight total of the bifunctional poly(arylene ether) and the alkyl styrene; and wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene; wherein the curable composition in the absence of optional filler has a viscosity of about 50 to about 600 centipoise at 23° C.

Another embodiment is a cured composition, comprising a reaction product obtained on curing a curable composition, wherein the curable composition comprises: about 40 to about 70 parts by weight of a bifunctional poly(arylene ether) having an intrinsic viscosity of about 0.03 to about 0.12 deciliter per gram, measured in chloroform at 25° C., wherein the bifunctional poly(arylene ether) has the structure

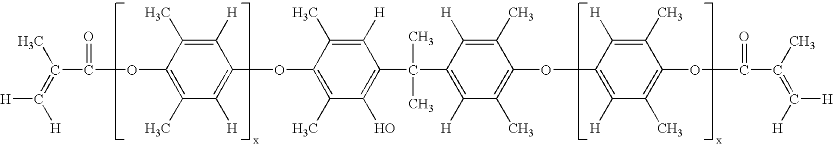

wherein each occurrence of x is independently 1 to about 20; and about 30 to about 60 parts by weight of an alkyl styrene selected from the group consisting of 2-methylstyrene, 4-methylstyrene, 2-tert-butylstyrene, 4-tert-butylstyrene, and mixtures thereof; wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene; and wherein the curable composition has a viscosity of about 50 to about 600 centipoise at 23° C.; wherein all parts by weight are based on 100 parts by weight total of the bifunctional poly(arylene ether) and the alkyl styrene.

Another embodiment is a cured composition, consisting of the reaction product obtained on curing a curable composition consisting of: about 40 to about 70 parts by weight of a bifunctional poly(arylene ether) having an intrinsic viscosity of about 0.03 to about 0.12 deciliter per gram, measured in chloroform at 25° C., wherein the bifunctional poly(arylene ether) has the structure

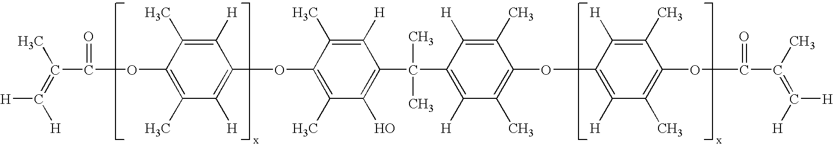

wherein each occurrence of x is independently 1 to about 20; about 30 to about 60 parts by weight of an alkyl styrene select from the group consisting of 2-methylstyrene, 4-methylstyrene, 2-tert-butylstyrene, 4-tert-butylstyrene, and mixtures thereof; optionally, about 2 to about 95 weight percent of a filler, based on the total weight of the composition; optionally, about 4 to about 16 parts by weight of divinylbenzene; optionally, a curing initiator, a curing inhibitor, or a combination thereof; and optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof; wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene; and wherein the curable composition has a viscosity of about 50 to about 600 centipoise at 23° C.; wherein all parts by weight are based on 100 parts by weight total of the bifunctional poly(arylene ether) and the alkyl styrene.

Another embodiment is a syntactic foam, comprising a reaction product obtained on curing a curable composition, wherein the curable composition comprises: a bifunctional poly(arylene ether) having an intrinsic viscosity of about 0.03 to about 0.2 deciliter per gram, measured in chloroform at 25° C.; an alkyl styrene having the structure

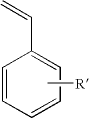

wherein R′ is C₁-C₆ primary or tertiary alkyl; and glass beads having a density less than or equal to 0.5 gram per milliliter and an isostatic crush strength of at least 10 megapascals, wherein 95 volume percent of beads have a diameter less than or equal to 200 micrometers; wherein the bifunctional poly(arylene ether) has a solubility in the alkyl styrene of at least 10 weight percent for seven days at 23° C., wherein the weight percent is based on the total weight of the bifunctional poly(arylene ether) and the alkyl styrene; and wherein the curable composition in the absence of the glass beads has a viscosity less than or equal to 2000 centipoise at 23° C.; and wherein the composition after curing has a density less than or equal to 0.9 gram per milliliter at 23° C.

These and other embodiments, including articles comprising the cured compositions, are described in detail below.

### DETAILED DESCRIPTION OF THE INVENTION

The present inventors have conducted extensive investigations in search of curable poly(arylene ether) compositions with more convenient processing characteristics and improved thermal, physical, and dielectric properties in the cured state. In the course of these investigations, the present inventors have discovered that the use of particular alkyl styrene compounds in combination with particular low molecular weight bifunctional poly(arylene ether)s allows the formulation of curable compositions that exhibit substantially improved properties relative to prior art compositions. In particular, the curable compositions described here exhibit markedly improved solubility of the poly(arylene ether) in the composition, which allows solvent-free preparation and processing of the composition at substantially lower temperatures than those used in the prior art. In many cases, the curable compositions exhibit solubility and viscosity properties that allow them to be stored and handled at room temperature without phase separation of the bifunctional poly(arylene ether). The compositions also exhibit an excellent balance of impact resistance, heat resistance, and dielectric properties after curing.

Thus, one embodiment is a curable composition, comprising: a bifunctional poly(arylene ether) having an intrinsic viscosity of about 0.03 to about 0.2 deciliter per gram, measured in chloroform at 25° C.; and an alkyl styrene having the structure

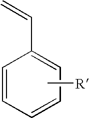

wherein R′ is C₁-C₆ primary or tertiary alkyl; wherein the bifunctional poly(arylene ether) has a solubility in the alkyl styrene of at least 10 weight percent for at least seven days at 23° C., wherein the weight percent is based on the total weight of the bifunctional poly(arylene ether) and the alkyl styrene; and wherein the curable composition has a viscosity less than or equal to 2000 centipoise at 23° C.

The bifunctional poly(arylene ether) has a solubility in the alkyl styrene of at least 10 weight percent for at least seven days at 23° C., wherein the weight percent is based on the total weight of the bifunctional poly(arylene ether) and the alkyl styrene. In some embodiments, the bifunctional poly(arylene ether) solubility is at least 20 weight percent, or at least 30 weight percent, or at least 40 weight percent, or at least 50 weight percent. In some embodiments, the bifunctional poly(arylene ether) solubility is up to about 80 weight percent, or up to about 70 weight percent, or up to about 60 weight percent. A specific procedure for conducting the solubility test is described in the working examples below. In some embodiments, the bifunctional poly(arylene ether) remains soluble in the alkyl styrene for seven days, or fourteen days, or one month, or even three months at 23° C.

One advantage of the composition that facilitates processing is its low viscosity. The curable composition has a viscosity less than or equal to 2000 centipoise at 23° C. In some embodiments, the curable composition has viscosity of at least about 10 centipoise, or at least about 20 centipoise, or at least about 50 centipoise. In some embodiments, the curable composition has viscosity less than or equal to 1000 centipoise, or less than or equal to 800 centipoise, or less than or equal to 600 centipoise.

The curable composition comprises a bifunctional poly(arylene ether). With respect to an individual poly(arylene ether) molecule, the term “bifunctional” means that the molecule has two polymerizable groups selected from aliphatic carbon-carbon double bonds and aliphatic carbon-carbon triple bonds. With respect to a poly(arylene ether) resin, the term “bifunctional” means that the resin comprises, on average, 1.6 to 2.4 of such polymerizable groups per poly(arylene ether) molecule. In some embodiments, the bifunctional poly(arylene ether) comprises, on average, 1.8 to 2.2 of such polymerizable groups per poly(arylene ether) molecule. As described in detail in the working examples, nuclear magnetic resonance spectroscopy can be used to determine whether a poly(arylene ether) is bifunctional.

The bifunctional poly(arylene ether) has an intrinsic viscosity of about 0.03 to about 0.2 deciliter per gram, measured in chloroform at 25° C. Within this range, the intrinsic viscosity may be at least about 0.06 deciliter per gram. Also within this range, the intrinsic viscosity may be up to about 0.15 deciliter per gram, or up to about 0.12 deciliter per gram. In some embodiments, the bifunctional poly(arylene ether) has an intrinsic viscosity of about 0.06 deciliter per gram. In some embodiments, the bifunctional poly(arylene ether) has an intrinsic viscosity of about 0.09 deciliter per gram.

In some embodiments, the bifunctional poly(arylene ether) has the structure

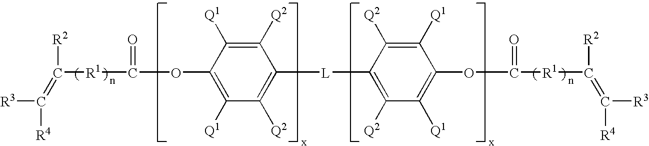

wherein each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of x is independently 1 to about 100; each occurrence of R¹ is independently C₁-C₁₂ hydrocarbylene; each occurrence of n is independently 0 or 1; each occurrence of R²-R⁴ is independently hydrogen or C₁-C₁₈ hydrocarbyl; and L has the structure

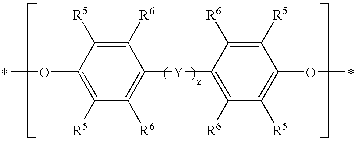

wherein each occurrence of R⁵ and R⁶ is independently selected from the group consisting of hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y has a structure selected from the group consisting of

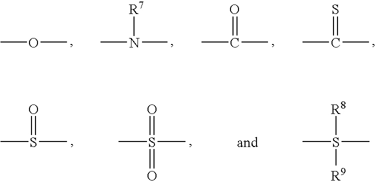

wherein each occurrence of R⁷ is independently selected from the group consisting of hydrogen and C₁-C₁₂ hydrocarbyl, and each occurrence of R⁸ and R⁹ is independently selected from the group consisting of hydrogen, C₁-C₁₂ hydrocarbyl hydrocarbyl (including, for example, C₃-C₈ cycloalkyl and phenyl), and C₁-C₆ hydrocarbylene wherein R⁸ and R⁹ collectively form a C₄-C₁₂ alkylene group. As used herein, the term “hydrocarbyl”, whether used by itself, or as a prefix, suffix, or fragment of another term, refers to a residue that contains only carbon and hydrogen. The residue may be aliphatic or aromatic, straight-chain, cyclic, bicyclic, branched, saturated, or unsaturated. It may also contain combinations of aliphatic, aromatic, straight chain, cyclic, bicyclic, branched, saturated, and unsaturated hydrocarbon moieties. The hydrocarbyl residue, when so stated however, may contain heteroatoms over and above the carbon and hydrogen members of the substituent residue. Thus, when specifically noted as containing such heteroatoms, the hydrocarbyl residue may also contain one or more carbonyl groups, amino groups, hydroxyl groups, or the like, or it may contain heteroatoms within the backbone of the hydrocarbyl residue.

In some embodiments, the bifunctional poly(arylene ether) has the structure

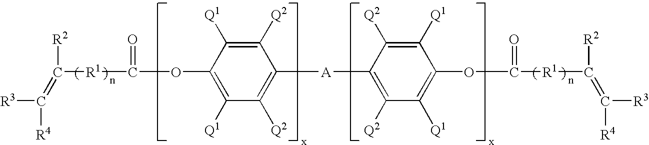

wherein each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of x is independently 1 to about 100; each occurrence of R¹ is independently C₁-C₁₂ hydrocarbylene; each occurrence of n is independently 0 or 1; each occurrence of R² and R³ and R⁴ is independently hydrogen or C₁-C₁₈ hydrocarbyl; and A has the structure

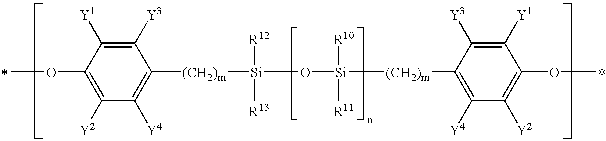

wherein each occurrence of R¹⁰ and R¹¹ and R¹² and R¹³ is independently hydrogen, C₁-C₁₂ hydrocarbyl or C₁-C₁₂ halohydrocarbyl; wherein each occurrence of m is independently 0, 1, 2, 3, 4, 5, or 6; and wherein each occurrence of Y¹ and Y² and Y³ and Y⁴ is independently hydrogen, C₁-C₁₂ hydrocarbyl, C₁-C₁₂ hydrocarbyloxy, or halogen; and wherein n is 5 to about 200. In some embodiments, Q¹ is methyl, each occurrence of Q² is independently hydrogen or methyl. In some embodiments, n is 0, R³ and R⁴ are hydrogen, and each occurrence of R² is independently hydrogen or methyl. In some embodiments, Y¹ is methoxy, and Y² and Y³ and Y⁴ are hydrogen. In some embodiments, m is 3, n is 5 to about 50, and R⁶, R⁷, R⁸, and R⁹ are methyl.

In some embodiments, the bifunctional poly(arylene ether) has the structure

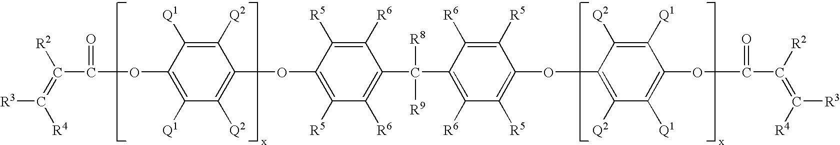

wherein Q¹ is methyl; each occurrence of Q² is independently hydrogen or methyl; each occurrence of R² is independently hydrogen or methyl; R³ and R⁴ are hydrogen; each occurrence of R⁵ and R⁶ is independently selected from the group consisting of hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; each occurrence of R⁸ and R⁹ is independently selected from the group consisting of hydrogen, C₁-C₁₂ hydrocarbyl, and C₁-C₆ hydrocarbylene wherein R⁸ and R⁹ collectively form a C₄-C₁₂ alkylene group; and each occurrence of x is independently 1 to about 50.

In some embodiments, the bifunctional poly(arylene ether) has the structure

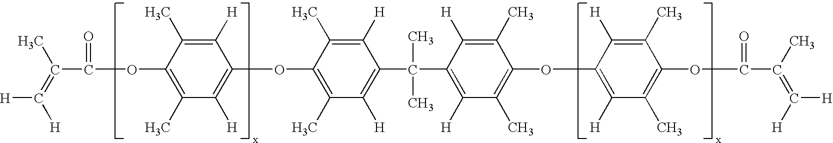

wherein each occurrence of x is independently 1 to about 20.

The bifunctional poly(arylene ether) may be produced by a process comprising oxidative copolymerization of a monohydric phenol and a dihydric phenol, followed by capping of the phenolic hydroxy groups by reaction with an unsaturated acid anhydride such as acrylic anhydride or methacrylic anhydride. Suitable monohydric phenols include, for example, 2,6-dimethylphenol, 2,3,6-trimethylphenol, and mixtures thereof. Suitable dihydric phenols include, for example, 3,3′,5,5′-tetramethyl-4,4′-biphenol, 2,2-bis(3-methyl-4-hydroxyphenyl)propane, 2,2-bis(3,5-dimethyl-4-hydroxyphenyl)propane, 1,1-bis(4-hydroxyphenyl)methane, 1,1-bis(4-hydroxyphenyl)ethane, 2,2-bis(4-hydroxyphenyl)propane 2,2-bis(4-hydroxyphenyl)butane, 2,2-bis(4-hydroxyphenyl)octane, 1,1-bis(4-hydroxyphenyl)propane, 1,1-bis(4-hydroxyphenyl)-n-butane, bis(4-hydroxyphenyl)phenylmethane, 1,1-bis(4-hydroxy-3-methylphenyl)cyclohexane, 1,1-bis(4-hydroxy-3,5-dimethylphenyl)cyclopentane, 1,1-bis(4-hydroxy-3,5-dimethylphenyl)cyclohexane, 1,1-bis(4-hydroxy-3-methylphenyl)cycloheptane, 1,1-bis(4-hydroxy-3,5-dimethylphenyl)cycloheptane, 1,1-bis(4-hydroxy-3-methylphenyl)cyclooctane, 1,1-bis(4-hydroxy-3,5-dimethylphenyl)cyclooctane, 1,1-bis(4-hydroxy-3-methylphenyl)cyclononane, 11,1-bis(4-hydroxy-3,5-dimethylphenyl)cyclononane, 1,1-bis(4-hydroxy-3-methylphenyl)cyclodecane, 1,1-bis(4-hydroxy-3,5-dimethylphenyl)cyclodecane, 1,1-bis(4-hydroxy-3-methylphenyl)cycloundecane, 1,1-bis(4-hydroxy-3,5-dimethylphenyl)cycloundecane, 1,1-bis(4-hydroxy-3-methylphenyl)cyclododecane, 1,1-bis(4-hydroxy-3,5-dimethylphenyl)cyclododecane, 1,1-bis(4-hydroxy-3-t-butylphenyl)propane, 2,2-bis(4-hydroxy-2,6-dimethylphenyl)propane 2,2-bis(4-hydroxy-3-bromophenyl)propane, 1,1-bis(4-hydroxyphenyl)cyclopentane, 1,1-bis(4-hydroxyphenyl)cyclohexane, and mixtures thereof. In some embodiments, the monohydric phenol is 2,6-dimethylphenol, and the dihydric phenol is 2,2-bis(3,5-dimethyl-4-hydroxyphenyl)propane. In some embodiments, the monohydric phenol is 2,6-dimethylphenol, and the dihydric phenol is selected from 2,2-bis(3-methyl-4-hydroxyphenyl)propane, 1,1-bis(4-hydroxy-3-methylphenyl)cycloheptane, 1,1-bis(4-hydroxy-3,5-dimethylphenyl)cycloheptane, and mixtures thereof. Procedures for capping poly(arylene ether)s with reactive groups are known in the art. One example of such a procedure is the reaction of the uncapped poly(arylene ether) with methacrylic anhydride in the presence of 4-(N,N-dimethylamino)pyridine as catalyst.

In addition to the bifunctional poly(arylene ether), the curable composition comprises an alkyl styrene having the structure

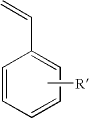

wherein R′ is C₁-C₆ primary or tertiary alkyl. Suitable C₁-C₆ primary or tertiary alkyl groups include, for example, methyl, ethyl, 1-propyl (n-propyl), 1,1-dimethylethyl (tert-butyl), 1-methylcyclopropyl, 2-methyl-1-butyl, 3-methyl-1-butyl, 2-methyl-2-butyl, 2,2-dimethyl-1-propyl (neopentyl), 1-methylcyclobutyl, 1,2-dimethylcyclopropyl, 1-hexyl, 2-methyl-1-pentyl, 3-methyl-1-pentyl, 4-methyl-1-pentyl, 3-methyl-3-pentyl, 2,2-dimethyl-1-butyl, 3,3-dimethyl-1-butyl, 2,3-dimethyl-1-butyl, 2,3-dimethyl-2-butyl, 1,2,2-trimethylcyclopropyl, (1,2-dimethylcyclopropyl)methyl, (2,2-dimethylcyclopropyl)methyl, 1,2,3-trimethylcyclopropyl, (2,3-dimethylcyclopropyl)methyl, (1-methylcyclobutyl)methyl, 1,2-dimethylcyclobutyl, (2-methylcyclobutyl)methyl, 1,3-dimethylcyclobutyl, (3-methylcyclobutyl)methyl, 1-methylcyclopentyl, cyclopentylmethyl, and the like. In some embodiments, the alkyl styrene is 3-methylstyrene, 4-methylstyrene, 3-tert-butylstyrene, 4-tert-butylstyrene, or a mixture thereof. In some embodiments, the alkyl styrene is 3-methylstyrene, 4-methylstyrene, or a mixture thereof. In some embodiments, the alkyl styrene is 4-methylstyrene. In some embodiments, the alkyl styrene is 3-tert-butylstyrene, 4-tert-butylstyrene, or a mixture thereof. In some embodiments, the alkyl styrene is 4-tert-butylstyrene.

The composition may comprise the bifunctional poly(arylene ether) and the alkyl styrene in widely varying amounts. In some embodiments, the composition comprises about 1 to about 90 parts by weight of the bifunctional poly(arylene ether) and about 10 to about 99 parts by weight of the alkyl styrene, based on 100 parts by weight total of the bifunctional poly(arylene ether) and the alkyl styrene. Within the above range, the bifunctional poly(arylene ether) amount may be at least about 10 parts by weight, or at least 20 parts by weight, or at least about 30 parts by weight, or at least about 40 parts by weight. Also within the above range, the bifunctional poly(arylene ether) amount may be up to about 80 parts by weight, or up to about 70 parts by weight, or up to about 60 parts by weight. Within the above range, the alkyl styrene amount may be at least about 20 parts by weight, or at least about 30 parts by weight, or at least about 40 parts by weight. Also within the above range, the alkyl styrene amount may be up to about 90 parts by weight, or up to about 80 parts by weight, or up to about 70 parts by weight, or up to about 60 parts by weight.

The curable composition may, optionally, further comprise styrene. When present, the styrene may be used in an amount of about 1 to about 99 parts by weight based on 100 parts by weight of the alkyl styrene.

The curable composition may, optionally, further comprise a crosslinker. A crosslinker is defined as a compound comprising at least two polymerizable groups selected from carbon-carbon double bonds, carbon-carbon triple bonds, and combinations thereof. In some embodiments, the crosslinker comprises at least three polymerizable groups, or at least four polymerizable groups, or at least five polymerizable groups. Suitable crosslinkers include, for example, divinylbenzenes, diallylbenzenes, trivinylbenzenes, triallylbenzenes, divinyl phthalates, diallyl phthalates, triallyl mesate, triallyl mesitate, triallyl cyanurate, triallyl isocyanurate, trimethylolpropane tri(meth)acrylate, 1,6-hexanediol di(meth)acrylate, neopentyl glycol di(meth)acrylate, dipropylene glycol di(meth)acrylate, ethylene glycol di(meth)acrylate, propylene glycol di(meth)acrylate, cyclohexanedimethanol di(meth)acrylate, butanediol di(meth)acrylate, diethylene glycol di(meth)acrylate, triethylene glycol di(meth)acrylate, isobornyl (meth)acrylate, methyl (meth)acrylate, methacryloxypropyl trimethoxysilane, bisphenol A dimethacrylate, (ethoxylated)₁₋₂₀ nonylphenol (meth)acrylates, (propoxylated)₁₋₂₀ nonylphenol (meth)acrylates, (ethoxylated)₁₋₂₀ tetrahydrofurfuryl (meth)acrylates, (propoxylated)₁₋₂₀ tetrahydrofurfuryl (meth)acrylates, (ethoxylated)₁₋₂₀ hydroxyethyl (meth)acrylates, (propoxylated)₁₋₂₀ hydroxyethyl (meth)acrylates, (ethoxylated)₂₋₄₀ 1,6-hexanediol di(meth)acrylates, (propoxylated)₂₋₄₀ 1,6-hexanediol di(meth)acrylates, (ethoxylated)₂₋₄₀ 1,4-butanediol di(meth)acrylates, (propoxylated)₂₋₄₀ 1,4-butanediol di(meth)acrylates, (ethoxylated)₂₋₄₀ 1,3-butanediol di(meth)acrylates, (propoxylated)₂₋₄₀ 1,3-butanediol di(meth)acrylates, (ethoxylated)₂₋₄₀ ethylene glycol di(meth)acrylates, (propoxylated)₂₋₄₀ ethylene glycol di(meth)acrylates, (ethoxylated)₂₋₄₀ propylene glycol di(meth)acrylates, (propoxylated)₂₋₄₀ propylene glycol di(meth)acrylates, (ethoxylated)₂₋₄₀ 1,4-cyclohexanedimethanol di(meth)acrylates, (propoxylated)₂₋₄₀ 1,4-cyclohexanedimethanol di(meth)acrylates, (ethoxylated)₂₋₄₀ bisphenol-A di(meth)acrylates, (propoxylated)₂₋₄₀ bisphenol-A di(meth)acrylates, (ethoxylated)₃₋₆₀ glycerol tri(meth)acrylates, (propoxylated)₃₋₆₀ glycerol tri(meth)acrylates, (ethoxylated)₃₋₆₀ trimethylolpropane tri(meth)acrylates, (propoxylated)₃₋₆₀ trimethylolpropane tri(meth)acrylates, (ethoxylated)₃₋₆₀ isocyanurate tri(meth)acrylates, (propoxylated)₃₋₆₀ isocyanurate tri(meth)acrylates, (ethoxylated)₄₋₈₀ pentaerythritol tetra(meth)acrylates, (propoxylated)₄₋₈₀ pentaerythritol tetra(meth)acrylates, (ethoxylated)₆₋₁₂₀ dipentaerythritol tetra(meth)acrylates, (propoxylated)₆₋₁₂₀ dipentaerythritol tetra(meth)acrylates, and the like, and mixtures thereof. In some embodiments, the crosslinker is divinylbenzene. In some embodiments, the composition is free of (meth)acrylate crosslinkers, where “(meth)acrylate” includes acrylate, methacrylate, and combinations thereof. In some embodiments, the curable composition as a whole is free of polymerizable groups such as acrylate and methacrylate, where an aliphatic carbon-carbon double bond and a carbonyl group are covalently linked by a single bond. When present, the crosslinker may be used in an amount of about 1 to about 50 parts by weight, based on 100 parts by weight total of the bifunctional poly(arylene ether) and the alkyl styrene. Within this range, the crosslinker amount may be at least about 3 parts by weight, or at least about 6 parts by weight. Also within this range, the crosslinker amount may be up to about 40 parts by weight, or up to about 30 parts by weight.

The curable composition may, optionally, further comprise a curing initiator, a curing inhibitor, or a combination thereof. Non-limiting examples of curing initiators include those described in U.S. Pat. No. 5,407,972 to Smith et al., U.S. Pat. No. 5,218,030 to Katayose et al., and U.S. Pat. No. 7,067,595 to Zarnoch et al. The curing initiator may include any compound capable of producing free radicals at elevated temperatures. Such curing initiators may include both peroxy and non-peroxy based radical initiators. Examples of useful peroxy initiators include, for example, benzoyl peroxide, dicumyl peroxide, methyl ethyl ketone peroxide, lauryl peroxide, cyclohexanone peroxide, t-butyl hydroperoxide, t-butyl benzene hydroperoxide, t-butyl peroctoate, 2,5-dimethylhexane-2,5-dihydroperoxide, 2,5-dimethyl-2,5-di(t-butylperoxy)-hex-3-yne, di-t-butylperoxide, t-butylcumyl peroxide, alpha,alpha′-bis(t-butylperoxy-m-isopropyl)benzene, 2,5-dimethyl-2,5-di(t-butylperoxy)hexane, di(t-butylperoxy)isophthalate, t-butylperoxy benzoate, 2,2-bis(t-butylperoxy)butane, 2,2-bis(t-butylperoxy)octane, 2,5-dimethyl-2,5-di(benzolyperoxy)hexane, di(trimethylsilyl)peroxide, trimethylsilylphenyltriphenylsilyl peroxide, and the like, and mixtures thereof. Suitable non-peroxy initiators include, for example, 2,3-dimethyl-2,3-diphenylbutane, 2,3-trimethylsilyloxy-2,3-diphenylbutane, and the like, and mixtures thereof. The curing initiator may further include any compound capable of initiating anionic polymerization of the unsaturated components. Such anionic polymerization initiators include, for example, alkali metal amides such as sodium amide (NaNH₂) and lithium diethyl amide (LiN(C₂H₅)₂), alkali metal and ammonium salts of C₁-C₁₀ alkoxides, alkali metal hydroxides, ammonium hydroxides, alkali metal cyanides, organometallic compounds such as the alkyl lithium compound n-butyl lithium, Grignard reagents such as phenyl magnesium bromide, and the like, and combinations thereof. In a preferred embodiment, the curing initiator may comprise t-butylperoxy benzoate or dicumyl peroxide. The curing initiator may promote curing at a temperature in a range of about 0° C. to about 200° C. When employed, the curing initiator is typically used in an amount of about 0.005 to about 1 part by weight per 100 parts by weight total of bifunctional poly(arylene ether) and alkyl styrene.

Suitable curing inhibitors include, for example, diazoaminobenzene, phenylacetylene, sym-trinitrobenzene, p-benzoquinone, acetaldehyde, aniline condensates, N,N′-dibutyl-o-phenylenediamine, N-butyl-p-aminophenol, 2,4,6-triphenylphenoxyl, pyrogallol, catechol, hydroquinone, monoalkylhydroquinones, p-methoxyphenol, t-butylhydroquinone, C₁-C₆-alkyl-substituted catechols (such as 4-tert-butylcatechol), dialkylhydroquinone, 2,4,6-dichloronitrophenol, halogen-ortho-nitrophenols, alkoxyhydroquinones, mono- and di- and polysulfides of phenols and catechols, thiols, oximes and hydrazones of quinone, phenothiazine, dialkylhydroxylamines, and the like, and combinations thereof. Suitable curing inhibitors further include poly(arylene ether)s having free hydroxyl groups. When present, the curing inhibitor amount may be about 0.001 to about 10 parts by weight per 100 parts by weight total of bifunctional poly(arylene ether) and alkyl styrene.

The curable composition may, optionally, further comprise an inorganic filler. Suitable inorganic fillers include, for example, alumina, silica (including fused silica and crystalline silica), boron nitride (including spherical boron nitride), aluminum nitride, silicon nitride, magnesia, magnesium silicate, glass fibers, glass mat, and the like, and combinations thereof. When present, the inorganic filler may be used in an amount of about 2 to about 95 weight percent, based on the total weight of the curable composition. In some embodiments, the curable composition comprises less than 50 weight percent filler, or less than 30 weight percent filler, or less than 10 weight percent filler. In some embodiments, the curable composition is free of inorganic filler (that is, no inorganic filler is intentionally added).

The composition may, optionally, further comprise one or more additives such as, for example, dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof.

One embodiment is a curable composition, consisting of: a bifunctional poly(arylene ether) having an intrinsic viscosity of about 0.03 to about 0.2 deciliter per gram, measured in chloroform at 25° C.; an alkyl styrene having the structure

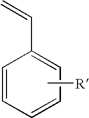

wherein R′ is C₁-C₆ primary or tertiary alkyl; optionally, a filler; optionally, a crosslinker selected from the group consisting of divinylbenzenes, diallylbenzenes, trivinylbenzenes, triallylbenzenes, divinyl phthalates, diallyl phthalates, triallyl mesate, triallyl mesitate, ethoxylated bisphenol A dimethacrylates, and mixtures thereof; optionally, a curing initiator, a curing inhibitor, or a combination thereof; and optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof; wherein the bifunctional poly(arylene ether) has a solubility in the alkyl styrene of at least 10 weight percent for at least seven days at 23° C.; and wherein the curable composition in the absence of optional filler has a viscosity less than or equal to 2000 centipoise at 23° C.

One embodiment is a curable composition comprising: about 30 to about 90 parts by weight of a bifunctional poly(arylene ether) having an intrinsic viscosity of about 0.03 to about 0.2 deciliter per gram, measured in chloroform at 25° C., wherein the bifunctional poly(arylene ether) has the structure

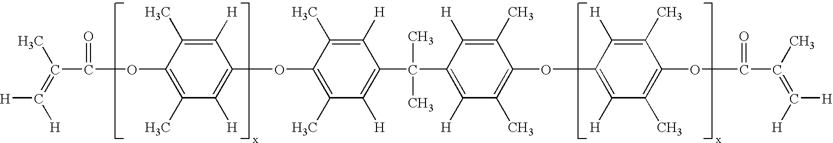

wherein each occurrence of x is independently 1 to about 20; and about 10 to about 70 parts by weight of an alkyl styrene selected from the group consisting of 2-methylstyrene, 4-methylstyrene, 2-tert-butylstyrene, 4-tert-butylstyrene, and mixtures thereof; wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene; wherein the curable composition has a viscosity of about 50 to about 600 centipoise at 23° C.; wherein all parts by weight are based on 100 parts by weight total of the bifunctional poly(arylene ether) and the alkyl styrene.

One embodiment is a curable composition, consisting of: about 30 to about 90 parts by weight of a bifunctional poly(arylene ether) having an intrinsic viscosity of about 0.03 to about 0.2 deciliter per gram, measured in chloroform at 25° C., wherein the bifunctional poly(arylene ether) has the structure

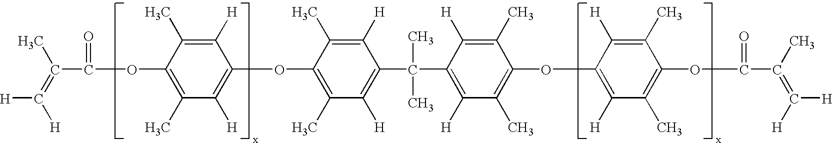

wherein each occurrence of x is independently 1 to about 20; and about 10 to about 70 parts by weight of an alkyl styrene selected from the group consisting of 2-methylstyrene, 4-methylstyrene, 2-tert-butylstyrene, 4-tert-butylstyrene, and mixtures thereof; optionally, about 2 to about 95 weight percent of a filler, based on the total weight of the composition; optionally, about 4 to about 16 parts by weight of divinylbenzene; optionally, a curing initiator, a curing inhibitor, or a combination thereof; and optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof; wherein all parts by weight are based on 100 parts by weight total of the bifunctional poly(arylene ether) and the alkyl styrene; and wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene; wherein the curable composition in the absence of optional filler has a viscosity of about 50 to about 600 centipoise at 23° C.

The curable composition may be used in the preparation of syntactic foams. Thus, one embodiment is a curable composition comprising: a bifunctional poly(arylene ether) having an intrinsic viscosity of about 0.03 to about 0.2 deciliter per gram, measured in chloroform at 25° C.; an alkyl styrene having the structure

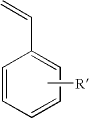

wherein R′ is C₁-C₆ primary or tertiary alkyl; and glass beads having a density less than or equal to 0.5 gram per milliliter and an isostatic crush strength of at least 10 megapascals, wherein 95 volume percent of beads have a diameter less than or equal to 200 micrometers; wherein the bifunctional poly(arylene ether) has a solubility in the alkyl styrene of at least 10 weight percent for seven days at 23° C., wherein the weight percent is based on the total weight of the bifunctional poly(arylene ether) and the alkyl styrene; and wherein the curable composition in the absence of the glass beads has a viscosity less than or equal to 2000 centipoise at 23° C.; and wherein the composition after curing has a density less than or equal to 0.9 gram per milliliter at 23° C. In some embodiments, the density of the glass beads may be less than or equal to 0.4 gram per milliliter, or less than or equal to 0.35 gram per milliliter at 25° C. In some embodiments, the isostatic crush strength of the glass beads is at least 20 megapascals, or at least 30 megapascals, measured at 25° C. In some embodiments, 95 volume percent of beads have a diameter less than or equal to 150 micrometers, or less than or equal to 100 micrometers. Suitable glass beads include the hollow glass beads available from 3M as Glass Bubbles D32/4500 having a density of 0.32 gram per milliliter, an isostatic crush strength of 31 megapascals (4,500 pounds per square inch), and 95 volume percent of beads with a diameter less than or equal to 85 micrometers. In some embodiments, the composition after curing has a density less than or equal to 0.8 gram per milliliter at 23° C.

The curable composition can be prepared and handled at temperatures lower than those used for prior art compositions. Thus, one embodiment is a method of preparing a curable composition, comprising: blending a bifunctional poly(arylene ether) having an intrinsic viscosity of about 0.03 to about 0.2 deciliter per gram, measured in chloroform at 25° C.; and an alkyl styrene having the structure

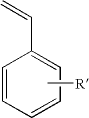

wherein R′ is C₁-C₆ primary or tertiary alkyl; wherein the bifunctional poly(arylene ether) has a solubility in the alkyl styrene of at least 10 weight percent for at least seven days at 23° C., wherein the weight percent is based on the total weight of the bifunctional poly(arylene ether) and the alkyl styrene; and wherein the curable composition has a viscosity less than or equal to 2000 centipoise at 23° C. In some embodiments, blending is conducted at a temperature less than or equal to 70° C., or less than or equal to 60° C., or less than or equal to 50° C., or less than or equal to 40° C., or less than or equal to 30° C. In some embodiments, blending is conducted in the absence of solvent. In some embodiments, the blending is conducted at a temperature less than or equal to 70° C. and in the absence of a solvent comprising an aliphatic carbon-carbon double bond or an aliphatic carbon-carbon triple bond. In this context, a solvent is defined as a compound lacking polymerizable functionality and used primarily to facilitate dissolution of the bifunctional poly(arylene ether) in the curable composition.

There is no particular limitation on the method by which the composition may be cured. The composition may, for example, be cured thermally or by using irradiation techniques, including radio frequency heating, UV irradiation, and electron beam irradiation. For example, the composition may be cured by initiating chain-reaction curing with 10 seconds of radio frequency heating. When heat curing is used, the temperature selected may be about 80° to about 300° C., and the heating period may be about 5 seconds to about 24 hours. Curing may be conducted in multiple steps using different times and temperatures for each step. For example, curing may be staged to produce a partially cured and often tack-free resin, which then is fully cured by heating for longer periods or at higher temperatures. One skilled in the thermoset arts is capable of determining suitable curing conditions without undue experimentation. In some embodiments, the composition may be partially cured. However, references herein to properties of the “cured composition” or the “composition after curing” generally refer to compositions that are substantially fully cured. One skilled in the thermoplastic arts may determine whether a sample is substantially fully cured without undue experimentation. For example, one may analyze the sample by differential scanning calorimetry to look for an exotherm indicative of additional curing occurring during the analysis. A sample that is substantially fully cured will exhibit little or no exotherm in such an analysis.

The invention includes articles comprising the partially or fully cured composition. The heat resistance, impact resistance, and excellent dielectric properties of the composition make it particularly useful for fabricating electronic components. The compositions described herein are also useful in the manufacture of syntactic foams such as those used as insulation materials and various fiber reinforcing applications such as bulk molding compounds and sheet molding compounds.

The invention is further illustrated by the following non-limiting examples.

### EXAMPLES 1-11, COMPARATIVE EXAMPLES 1-11

These eleven examples and eleven comparative examples demonstrate the preparation and curing of compositions comprising alkyl styrene and monofunctional or bifunctional poly(arylene ether). The inventive examples used bifunctional poly(arylene ether) whereas the comparative examples used monofunctional poly(arylene ether).

Characteristics of the poly(arylene ether) resins before methacrylate capping (“uncapped PPE”) are presented in Table 1. In the context of the uncapped poly(arylene ether)s only, “functionality” and “monofunctional” and “bifunctional” refer to the average number of hydroxy groups per molecule rather than the average number of polymerizable groups per molecule. Intrinsic viscosities were measured at 25° C. in chloroform on poly(arylene ether) samples that had been dried for 1 hour at 125° C. under vacuum. Values of number average molecular weight (Mₙ), weight average molecular weight (M_{w}), and polydispersity (M_{w}/Mₙ) were determined by gel permeation chromatography (GPC). The chromatographic system consisted of an Agilent Series 1100 system, including isocratic pump, autosampler, thermostatted column compartment, and multi-wavelength detector. The elution solvent was chloroform with 50 parts per million by weight of di-n-butylamine. Sample solutions were prepared by dissolving 0.01 gram of sample in 20 milliliters chloroform with toluene (0.25 milliliter per liter) as an internal marker. The sample solutions were filtered through a Gelman 0.45 micrometer syringe filter before GPC analysis; no additional sample preparation was performed. The injection volume was 50 microliters and the eluent flow rate was set at 1 milliliter/minute. Two Polymer Laboratories GPC columns (Phenogel 5 micron linear (2), 300×7.80 millimeters) connected in series were used for separation of the sample. The detection wavelength was set at 280 nanometers. The data were acquired and processed using an Agilent ChemStation with integrated GPC data analysis software. The molecular weight distribution results were calibrated with polystyrene standards. The results are reported without any correction as “Mₙ (AMU)” and “M_{w} (AMU)”.

The uncapped poly(arylene ether)s were analyzed by proton nuclear magnetic resonance spectroscopy (¹H NMR) to determine the concentration of hydroxyl end groups (in parts per million by weight). The relative amounts of internal units (including 2,6-dimethyl-1,4-phenylene ether units, divalent groups derived from 3,3′,5,5′-tetramethyl-4,4′-biphenol, and divalent units derived from 2,2-bis(3,5-dimethyl-4-hydroxy)propane) and terminal units (including 2,6-dimethyl-1-hydroxy-phen-4-yl units, 2,6-dimethyl-phen-1-yl units, monovalent phenolic units derived from 2,2-bis(3,5-dimethyl-4-hydroxy)propane, and monovalent dibutylamine-substituted phenolic groups derived from 2,6-dimethylphenol and dibutylamine catalyst) were determined by integrating the associated resonances and adjusting for the number of protons giving rise to the resonance. Values of number average molecular weight were then calculated based on the relative amounts of internal units and total terminal units. Values of hydroxyl end group content were calculated based on the relative amounts of terminal phenolic groups and total terminal and internal units. Values of hydroxyl (OH) group content are expressed in parts per million by weight (ppm), where the hydroxyl groups were assigned a molecular weight of 17 grams per mole. “Functionality” is the average number of hydroxyl groups per molecule of poly(arylene ether). Functionality is calculated according to the formula

Functionality=2*mol OH-endgroups/(mol of all endgroups)

where “mol OH-endgroups” is the moles of hydroxyl endgroups, and “mol of all endgroups” is the moles of all endgroups, which includes hydroxyl endgroups and so-called “tail groups” which in this case are 2,6-dimethylphenyl groups.

TABLE 1

| | uncapped | uncapped | uncapped | uncapped |
|---|---|---|---|---|
| | PPE 0.12 | PPE 0.09 | PPE 0.06 | PPE 0.12 |
| | bifxl. | bifxl. | bifxl. | monofxl. |
| IV (dL/g) | 0.116 | 0.087 | 0.067 | 0.124 |
| Mₙ (AMU) | 1921 | 1198 | 799 | 1964 |
| M_{w} (AMU) | 4378 | 2477 | 1690 | 5148 |
| M_{w}/Mₙ | 2.28 | 2.07 | 2.12 | 2.62 |
| OH content (ppm) | 11900 | 21800 | 28200 | 8400 |
| OH Functionality | 1.90 | 1.91 | 1.92 | 1.12 |

Characteristics of the poly(arylene ether) resins after methacrylate capping are presented in Table 2. Glass transition temperature values, expressed in degrees centigrade (° C.), were measured by differential scanning calorimetry.

TABLE 2

| | PPE | | | PPE monofxl. |
|---|---|---|---|---|
| | bifxl. 0.12 | PPE bifxl. 0.09 | PPE bifxl 0.06 | 0.12 |
| IV (dL/g) | 0.12 | 0.09 | 0.06 | 0.12 |
| Hydroxyl | 56 | 74 | 97 | 85 |
| content | | | | |
| (ppm) | | | | |
| T_{g} (° C.) | 164 | 154 | 101 | 165 |

Curable composition components and amounts are presented in Table 2, where amounts are expressed in parts by weight (pbw). The monofunctional poly(arylene ether) (designated “PPE monofxl. 0.12” in Tables 2 and 3) was a methacrylate-capped poly(2,6-dimethyl-1,4-phenylene ether) resin, prepared by oxidative polymerization of 2,6-dimethylphenol followed by methacrylate capping using methacrylic anhydride; it had an intrinsic viscosity of 0.12 deciliter per gram (dL/g) measured at 25° C. in chloroform. The bifunctional poly(arylene ether)s were prepared by oxidative copolymerization of 2,6-dimethylphenol and 2,2-bis(4-hydroxy-3,5-dimethylphenyl)propane followed by methacrylate capping using methacrylic anhydride. They had intrinsic viscosities of 0=12 dL/g (designated “PPE bifxl. 0.12” in Tables 2 and 3) and 0.09 dL/g (designated “PPE bifxl. 0.09” in Tables 2 and 3).

The polymerization inhibitor 4-tert-butylcatechol was obtained from Aldrich Chemical Co. The alkyl styrene monomers 4-tert-butylstyrene and 4-methylbutylstyrene were supplied by Deltech Corporation. The crosslinker ethoxylated bisphenol A dimethacrylate was obtained from Sartomer Company under the designation SR-348, and the internal mold release from Stepan Company under the designation Zelec UN. The polymerization initiator 2,5-dimethyl-2,5-di(tert-butylperoxy)hexane was obtained from Akzo-Nobel under the designation Trigonox 101.

All curable compositions were prepared according to the following general procedure. The poly(arylene ether) and 4-tert-butylcatechol were dissolved in 4-tert-butylstyrene or 4-methylbutylstyrene at 90° C. Next, the ethoxylated bisphenol A dimethacrylate was added to the mixture, followed by the addition of the internal mold release. The polymerization initiator, 2,5-dimethyl-2,5-di(tert-butylperoxy)hexane, was then added and thoroughly mixed. The mixture was degassed in a vacuum oven at 100° C. and 25 inches of mercury vacuum, and then it was poured into the mold that had been preheated to 100° C. The filled mold was then placed in an oven at 100° C. for 90 minutes. The oven temperature was then increased to 110° C. where it was kept for 60 minutes. The oven temperature was then raised to 150° C. where it was kept for another 10 minutes. The oven was subsequently turned off and the mold was allowed to cool to room temperature inside the oven. The cured plaque was removed from the mold and cut into test specimens. The specimen thickness is 3.175 millimeters (⅛ inch). The cutter make is a diamond-wheeled wet saw obtained as 158189 MK-100 Tile Saw from MK Diamond Products, Inc. The Blade is a MK-225, 25.4 centimeter (10 inch) diameter diamond blade with a thickness of 1.27 millimeters (0.05 inches). In order to minimize any chipping along the cutting edge, the samples were placed on a plastic or wood backing material when cutting. Comparative Examples 6, 7, 10, and 11, which contained 35 pbw monofunctional poly(arylene ether), could not be prepared. Although the poly(arylene ether) could be dissolved at 160° C., when the mixture was cooled to below 100° C. in order to add the peroxide, there was a substantial increase in viscosity that prevented effective mixing and degassing.

Properties of the cured compositions are summarized in Table 3. Values of flexural modulus and flexural stress at break, both expressed in megapascals (MPa), were measured at 23° C. according to ASTM D 790-03, Method A, on samples having dimensions 1.27 centimeters (0.5 inch) by 12.7 centimeters (5 inches) by 3.175 millimeters (0.125 inch). The support span length was 5.08 centimeters (2 inches). The rate of crosshead motion was 1.27 millimeters/minute (0.05 inch/minute).

Density values, expressing in grams per milliliter (g/mL), were measured according to ASTM D 792-00 in water. Glass transition temperature values, expressed in degrees centigrade (° C.), were measured by differential scanning calorimetry.

Heat deflection temperature values, expressed in degrees centigrade, were measured automatically according to ASTM D 648-06, Method B, using a 0.45 megapascal force on samples having a width of 1.27 centimeters (0.5 inch) and a depth of 3.175 millimeters (0.125 inch). The immersion medium was silicone fluid. Tests were conducted by heating the immersion medium, initially at a temperature of 23° C., at a rate of 2° C. per minute.

Unnotched Izod impact strength values, expressed in joules per meter (J/m), were measured at 23° C. according to ASTM D 4812-06, using samples having a width of 1.27 centimeters (0.5 inch) and a depth of 3.175 millimeters (0.125 inch). The samples were cut from the molded bars described above. The apparatus used a 0.907 kilogram (2.00 pound) hammer.

Notched Izod impact strength values, expressed in joules per meter (J/m), were measured according to ASTM D 256-06, Method A, at 23° C. using a 0.907 kilogram (2.00 pound) hammer, and specimens having a notch such that at least 1.02 centimeter (0.4 inch) of the original 1.27 centimeter (0.5 inch) depth remained under the notch. The specimens were conditioned for 24 hours at 23° C. after notching.

Dielectric constant (“Dₖ”) values and dissipation factor (“D_{f}”) values were measured at 23° C. according to IPC-TM-650-2.5.5.9. Samples were rectangular prisms having dimensions 5 centimeters by 5 centimeters by 3.5 millimeters. Samples were conditioned at 23° C. and 50% relative humidity for a minimum of 24 hours before testing. The measuring cell was a Hewlett-Packard Impedance Material Analyzer model 4291B and had a width of 27.5 centimeters, a height of 9.5 centimeters, and a depth of 20.5 centimeters. The electrodes were Hewlett-Packard Model 16453A and had a diameter of 7 millimeters. Measurements were conducted using a capacitance method sweeping a range of frequency when DC voltage was applied to the dielectric materials. The applied voltage was 0.2 millivolt to 1 volt at the frequency range of 1 megahertz to 1 gigahertz. Table 3 provides values for dielectric constants and dissipation factors at frequencies of 100 megahertz, 500 megahertz, and 1 gigahertz.

Property values are summarized in Table 3.

TABLE 3

| | | C. | | C. | | C. | | C. |
|---|---|---|---|---|---|---|---|---|
| | Ex. 1 | Ex. 1 | Ex. 2 | Ex. 2 | Ex. 3 | Ex. 3 | Ex. 4 | Ex. 4 |
| Compositions | | | | | | | | |
| PPE bifxl. 0.12 | 25 | 0 | 20.83 | 0 | 20.83 | 0 | 25 | 0 |
| PPE bifxl. 0.09 | 0 | 0 | 0 | 0 | 0 | 0 | 0 | 0 |
| PPE monofxl. 0.12 | 0 | 25 | 0 | 20.83 | 0 | 20.83 | 0 | 25 |
| 4-tert-Butylstyrene | 62.5 | 62.5 | 64.58 | 64.58 | 58.33 | 58.33 | 50 | 50 |
| 4-Methylstyrene | 0 | 0 | 0 | 0 | 0 | 0 | 0 | 0 |
| Mold release | 1 | 1 | 1 | 1 | 1 | 1 | 1 | 1 |
| Crosslinker | 12.5 | 12.5 | 14.58 | 14.58 | 20.8 | 20.8 | 25 | 25 |
| Initiator | 1.5 | 1.5 | 1.5 | 1.5 | 1.5 | 1.5 | 1.5 | 1.5 |
| Inhibitor | 0.04 | 0.04 | 0.04 | 0.04 | 0.04 | 0.04 | 0.04 | 0.04 |
| Properties | | | | | | | | |
| Flex. Mod. (MPa) | 2470 | 2630 | 2490 | 2580 | 2590 | 2630 | 2760 | 2670 |
| Flex. Stress@Bk | 70.5 | 69.4 | 68.1 | 72.8 | 66.4 | 69.2 | 76.1 | 69.2 |
| (MPa) | | | | | | | | |
| Density (g/mL) | 1.019 | 1.013 | 1.011 | 1.011 | 1.015 | 1.011 | 1.041 | 1.040 |
| T_{g} (° C.) | 147 | — | 144 | — | 147 | — | 148 | — |
| HDT (° C.) | 146 | 123 | 148 | 133 | 151 | 143 | 155 | 146 |
| Unnotched Izod (J/m) | 108.0 | 83.4 | 142.0 | 126.2 | 122.0 | 103.2 | 123.0 | 108.6 |
| Notched Izod (J/m) | 19.2 | 12.4 | 18.8 | 12.0 | 18.4 | 11.4 | 20.1 | 11.4 |
| Dₖ @ 100 MHz | 2.47 | — | 2.45 | — | 2.53 | — | 2.54 | — |
| Dₖ @ 500 MHz | 2.45 | — | 2.43 | — | 2.51 | — | 2.51 | — |
| Dₖ @ 1 GHz | 2.43 | — | 2.41 | — | 2.50 | — | 2.50 | — |
| D_{f} @ 100 MHz | 0.002 | — | 0.002 | — | 0.003 | — | 0.004 | — |
| D_{f} @ 500 MHz | 0.001 | — | 0.001 | — | 0.003 | — | 0.003 | — |
| D_{f} @ 1 GHz | — | — | — | — | 0.003 | — | 0.002 | — |

| | | C. | | C. | | C. |
|---|---|---|---|---|---|---|
| | Ex. 5 | Ex. 5 | Ex. 6 | Ex. 6 | Ex. 7 | Ex. 7 |
| Compositions | | | | | | |
| PPE bifxl. 0.12 | 20.83 | 0 | 0 | 0 | 0 | 0 |
| PPE bifxl. 0.09 | 0 | 0 | 35 | 0 | 35 | 0 |
| PPE monofxl. 0.12 | 0 | 20.83 | 0 | 35 | 0 | 35 |
| 4-tert-Butylstyrene | 54.17 | 54.17 | 40 | 40 | 44.17 | 44.17 |
| 4-Methylstyrene | 0 | 0 | 0 | 0 | 0 | 0 |
| Mold release | 1 | 1 | 1 | 1 | 1 | 1 |
| Crosslinker | 25 | 25 | 25 | 25 | 20.8 | 20.8 |
| Initiator | 1.5 | 1.5 | 1.5 | 1.5 | 1.5 | 1.5 |
| Inhibitor | 0.04 | 0.04 | 0.04 | 0.04 | 0.04 | 0.04 |
| Properties | | | | | | |
| Flex. Mod. (MPa) | 2710 | 2690 | 2796 | * | 2645 | * |
| Flex. Stress@Bk | 85.7 | 76.1 | 83.6 | * | 91.40 | * |
| (MPa) | | | | | | |
| Density (g/mL) | 1.035 | 1.036 | 1.049 | * | 1.095 | * |
| T_{g} (° C.) | 148 | — | 157 | * | 153 | * |
| HDT (° C.) | 149 | 144 | 160 | * | 156 | * |
| Unnotched Izod (J/m) | 108.0 | 87.7 | 195.0 | * | 204.4 | * |
| Notched Izod (J/m) | 19.2 | 11.1 | 22.3 | * | 23.6 | * |
| Dₖ @ 100 MHz | 2.56 | — | — | * | — | * |
| Dₖ @ 500 MHz | 2.52 | — | — | * | — | * |
| Dₖ @ 1 GHz | 2.48 | — | — | * | — | * |
| D_{f} @ 100 MHz | 0.003 | — | — | * | — | * |
| D_{f} @ 500 MHz | 0.002 | — | — | * | — | * |
| D_{f} @ 1 GHz | 0.002 | — | — | * | — | * |

| | | | | | Ex. | C. Ex. | Ex. | C. Ex. |
|---|---|---|---|---|---|---|---|---|
| | Ex. 8 | C. Ex. 8 | Ex. 9 | C. Ex. 9 | 10 | 10 | 11 | 11 |
| Compositions | | | | | | | | |
| PPE bifxl. 0.12 | 25 | 0 | 20.83 | 0 | 0 | 0 | 0 | 0 |
| PPE bifxl. 0.09 | 0 | 0 | 0 | 0 | 35 | 0 | 35 | 0 |
| PPE monofxl. 0.12 | 0 | 25 | 0 | 20.83 | 0 | 35 | 0 | 35 |
| 4-tert-Butylstyrene | 0 | 0 | 0 | 0 | 0 | 0 | 0 | 0 |
| 4-Methylstyrene | 50 | 50 | 54.166 | 54.17 | 40 | 40 | 44.17 | 44.17 |
| Mold release | 1 | 1 | 1 | 1 | 1 | 1 | 1 | 1 |
| Crosslinker | 25 | 25 | 25 | 25 | 25 | 25 | 20.83 | 20.83 |
| Initiator | 1.5 | 1.5 | 1.5 | 1.5 | 1.5 | 1.5 | 1.5 | 1.5 |
| Inhibitor | 0.04 | 0.04 | 0.04 | 0.04 | 0.04 | 0.04 | 0.04 | 0.04 |
| Properties | | | | | | | | |
| Flex. Mod. (MPa) | 2975 | 2890 | 3042 | 3000 | 3021 | * | 3014 | * |
| Flex. Stress@Bk (MPa) | 98 | 96 | 86 | 83 | 101 | * | 104 | * |
| Density (g/mL) | 1.085 | 1.081 | 1.080 | 1.079 | 1.099 | * | 1.096 | * |
| T_{g} (° C.) | — | — | — | — | — | * | — | * |
| HDT (° C.) | 132 | 124 | 139 | 126 | 138 | * | 145 | * |
| Unnotched Izod (J/m) | 147.2 | 131.0 | 187.4 | 169.0 | 205.7 | * | 214.4 | * |
| Notched Izod (J/m) | 23.1 | 19.1 | 24.6 | 15.9 | 25.3 | * | 26.6 | * |
| Dₖ @ 100 MHz | — | — | — | — | — | * | — | * |
| Dₖ @ 500 MHz | — | — | — | — | — | * | — | * |
| Dₖ @ 1 GHz | — | — | — | — | — | * | — | * |
| D_{f} @ 100 MHz | — | — | — | — | — | * | — | * |
| D_{f} @ 500 MHz | — | — | — | — | — | * | — | * |
| D_{f} @ 1 GHz | — | — | — | — | — | * | — | * |

* Curable composition could not be prepared. Sample was too thick and cured while trying to dissolve PPE

Examples 1-7 and Comparative Examples 1-7 illustrate the effect of poly(arylene ether) type in compositions comprising 4-tert-butylstyrene. At equivalent poly(arylene ether) levels, the data show that the resins that contain the bifunctional poly(arylene ether) (Examples 1-7) exhibit superior property values, such as higher heat deflection temperatures, and higher unnotched and notched Izod impact strength values, compared to corresponding compositions using the monofunctional poly(arylene ether) (Comparative Examples 1-5). In addition, the heat deflection temperatures and the notched and unnotched Izod impact strengths increase with increasing levels of poly(arylene ether). The dielectric constant and dissipation factor decrease with increasing poly(arylene ether) levels. As noted previously, Comparative Examples 6 and 7 could not be made due to viscosity limitations.

Examples 8-11 and Comparative Examples 8-11 illustrate the effect of poly(arylene ether) type in compositions comprising 4-methylstyrene. At equivalent poly(arylene ether) levels, the data show that the resins that contain bifunctional poly(arylene ether) (Examples 8-11) exhibit superior properties, such as higher heat deflection temperatures and higher unnotched and notched Izod impact strengths, compared to Comparative Examples 8 and 9 made using the monofunctional poly(arylene ether). As noted previously, Comparative Examples 10 and 11 could not be made due to viscosity limitations.

### EXAMPLES 12-15, COMPARATIVE EXAMPLES 12-14

Examples of compositions comprising bifunctional poly(arylene ether) with intrinsic viscosity of 0.06 dL/g, measured at 25° C. in chloroform, are shown in Table 4. This poly(arylene ether) was prepared by oxidative copolymerization of 2,6-dimethylphenol and 2,2-bis(4-hydroxy-3,5-dimethylphenyl)propane followed by methacrylate capping using methacrylic anhydride. The property results in Table 4 show that addition of the bifunctional poly(arylene ether) is associated with increased glass transition temperature, increased heat deflection temperature, and increased notched and unnotched Izod impact strengths compared to poly(4-tert-butystyrene) alone (Examples 12-15 versus Comparative Example 12). The results also show that the combination of the bifunctional poly(arylene ether) and the alkyl styrene is associated with increased glass transition temperature and increased notched and unnotched Izod impact strengths compared to the combination of bifunctional poly(arylene ether) and triallyl isocyanurate (Examples 12-15 versus Comparative Example 13). In addition, the bifunctional poly(arylene ether)/4-tert-butylstyrene examples have higher ductility, and lower dielectric constants and dissipation factors than the bifunctional poly(arylene ether)/triallyl isocyanurate (TAIC) example (Example 15 versus Comparative Example 13) or the t-butylstyrene/triallyl isocyanurate example (Example 15 versus Comparative Example 14).

TABLE 4

| | C. Ex. | | | | | C. Ex. | C. Ex. |
|---|---|---|---|---|---|---|---|
| | 12 | Ex. 12 | Ex. 13 | Ex. 14 | Ex. 15 | 13 | 14 |
| Compositions | | | | | | | |
| tert-Butylstyrene | 100 | 40 | 50 | 30 | 40 | 0 | 50 |
| Divinylbenzene | 0 | 0 | 0 | 10 | 10 | 0 | 0 |
| PPE bifxl. 0.06 | 0 | 60 | 50 | 60 | 50 | 60 | 0 |
| TAIC | 0 | 0 | 0 | 0 | 0 | 40 | 50 |
| Initiator | 1.5 | 1.5 | 1.5 | 1.5 | 1.5 | 1.5 | 1.5 |
| Inhibitor | 0.04 | 0.04 | 0.04 | 0.04 | 0.04 | 0.025 | 0.025 |
| Properties | | | | | | | |
| Density (g/mL) | 0.9531 | 1.0409 | 1.0213 | 1.0479 | 1.0238 | — | — |
| Tg (° C.) | 120 | 169 | 169 | 177 | 174 | 139 | — |
| HDT (° C.) | 116 | 169 | 169 | 179 | 177 | 183 | — |
| Unnotched Izod (J/m) | 56.8 | 110.6 | 108.6 | 61.3 | 58.8 | 24.4 | — |
| Notched Izod (J/m) | 17.6 | 16.9 | 20.2 | 19.7 | 19.5 | — | — |
| Dₖ @ 1 GHz | 2.41 | — | — | — | 2.55 | — | 2.76 |
| Dₖ @ 2.4 GHz | 2.41 | — | — | — | 2.60 | — | 2.81 |
| Dₖ @ 10 GHz | 2.37 | — | — | — | 2.52 | — | 2.73 |
| D_{f} @ 1 GHz | 0.0020 | — | — | — | 0.0038 | — | 0.0053 |
| D_{f} @ 2.4 GHz | 0.0019 | — | — | — | 0.0049 | — | 0.0058 |
| D_{f} @ 10 GHz | 0.0029 | — | — | — | 0.0047 | — | 0.0078 |

### EXAMPLES 16-30

Examples 16-30 illustrate additional compositions with a bifunctional poly(arylene ether) having an intrinsic viscosity of 0.09 dL/g. Viscosity values for the curable (uncured) compositions, expressed in centipoise (cps), were measured using a Brookfield digital Viscometer, Model DV-II, following the procedure in accompanying Manufacturing Operation Manual No: m/85-160-G. Compression strength values and compression modulus values, both expressed in megapascals (MPa), were measured for the cured compositions at 23° C. according to ASTM D4762-04 on samples having dimensions 1.25 centimeters by 1.25 centimeters by 5.08 centimeters. Shore D hardness values were measured for the cured compositions at 23° C. according to ASTM D2240-05. The data in Table 5 show that glass transition temperature and compression strength values increase with increasing poly(arylene ether) content.

TABLE 5

| | Ex. 16 | Ex. 17 | Ex. 18 | Ex. 19 | Ex. 20 | Ex. 21 | Ex. 22 |
|---|---|---|---|---|---|---|---|
| Compositions | | | | | | | |
| PPE bifxl. 0.09 | 30 | 40 | 50 | 35 | 40 | 40 | 30 |
| 4-tert- | 70 | 60 | 50 | 61 | 56 | 48 | 62 |
| Butylstyrene | | | | | | | |
| Divinylbenzene | 0 | 0 | 0 | 4 | 4 | 12 | 8 |
| Inhibitor | 0.14 | 0.14 | 0.14 | 0.14 | 0.14 | 0.14 | 0.14 |
| Initiator | 1.43 | 1.43 | 1.43 | 1.43 | 1.43 | 1.43 | 1.43 |
| Properties | | | | | | | |
| Viscosity (cps) | 75.2 | 314 | 581 | 180.8 | 381.6 | 280.8 | 64 |
| Density (g/mL) | 0.9958 | 1.0050 | 1.0215 | 1.0025 | 1.0138 | 1.0137 | 0.9941 |
| Tg (° C.) | 139.5 | 162.3 | 170.5 | 157.5 | 161.9 | 170.7 | 147.5 |
| Compression | 105.7 | 110.3 | 117.4 | 109.3 | 111.3 | 111.6 | 103.6 |
| Strength (MPa) | | | | | | | |
| Compression | 2108 | 2283 | 2445 | 2304 | 2357 | 2328 | 2207 |
| Modulus | | | | | | | |
| (MPa) | | | | | | | |
| Hardness, | 76.7 | 77.6 | 84.4 | 83.4 | 84.0 | 80.2 | 85.4 |
| Shore D | | | | | | | |
| | Ex. 23 | Ex. 25 | Ex. 26 | Ex. 27 | Ex. 28 | Ex. 29 | Ex. 30 |
| Compositions | | | | | | | |
| PPE, | 35 | 40 | 45 | 50 | 30 | 40 | 50 |
| bifunctional, | | | | | | | |
| 0.09 dL/g | | | | | | | |
| tert- | 57 | 52 | 47 | 42 | 54 | 44 | 34 |
| Butylstyrene | | | | | | | |
| Divinylbenzene | 8 | 8 | 8 | 8 | 16 | 16 | 16 |
| Inhibitor | 0.14 | 0.14 | 0.14 | 0.14 | 0.14 | 0.14 | 0.14 |
| Initiator | 1.43 | 1.43 | 1.43 | 1.43 | 1.43 | 1.43 | 1.43 |
| Properties | | | | | | | |
| Viscosity (cps) | 101.6 | 216 | 349.6 | 442 | 48 | 264.8 | 497 |
| Density (g/mL) | 1.0056 | 1.0140 | 1.019 | 1.0250 | 1.0067 | 1.0195 | 1.0317 |
| Tg (° C.) | 154.9 | 154.9 | 178.4 | 182.9 | 157.4 | 176.5 | 189.9 |
| Compression | 105.0 | 106.5 | 109.3 | 110.7 | 105.6 | 108.9 | 114.2 |
| Strength (MPa) | | | | | | | |
| Compression | 2235 | 2284 | 2332 | 2359 | 2241 | 2256 | 2395 |
| Modulus | | | | | | | |
| (MPa) | | | | | | | |
| Hardness, | 84.4 | 83.2 | 79.5 | 82.4 | 84.7 | 86.8 | 85.0 |
| Shore D | | | | | | | |

### EXAMPLE 31

A curable composition was prepared by methacrylate-capping a poly(arylene ether) in 4-tert-butylstyrene, then adding additional components. The bifunctional poly(arylene ether) starting material was a copolymer of 2,6-dimethylphenol and 2,2-bis(4-hydroxy-3,5-dimethylphenyl)propane having an intrinsic viscosity of 0.09 dL/g, measured at 25° C. in chloroform. To prepare the capped poly(arylene ether) in 4-tert-butylstyrene, the 4-tert-butylstyrene (1500 grams) was combined with 4-tert-butylcatechol (2.5 grams) and poly(arylene ether) starting material (1500 grams). This mixture was heated to 80° C. and agitated to dissolve the bifunctional poly(arylene ether). Once the bifunctional poly(arylene ether) was dissolved, 4-dimethylaminopyridine (33 grams) and methacrylic anhydride (470 grams) were added. The reaction mixture was maintained at 80° C. for four hours, after which additional 4-tert-butylcatechol (2.5 grams) was added, and the mixture was cooled to below 45° C. Crosslinker (divinylbenzene, 300 grams) and curing initiator (2,5-dimethyl-2,5-di(tert-butylperoxy)hexane, obtained from Akzo Nobel as Trigonox 101, 31 grams) were then added to complete the curable composition.

The curable composition was used to prepare a syntactic foam. The syntactic foam was made by mixing the resin with hollow glass beads. Hollow glass beads having a density of 0.32 gram per milliliter, an isostatic crush strength of 31 megapascals (4,500 pounds per square inch), and 95 volume percent of beads with a diameter less than or equal to 85 micrometers were obtained as Glass Bubbles D32/4500 from 3M. The cured neat resin (without glass beads) had a density of 1.024 grams per milliliter. Syntactic foam with 50 percent by volume glass beads was prepared. Properties of the syntactic foam appear in Table 6.

TABLE 6

| | Example 31 |
|---|---|
| Composition | |
| Resin | 1792 |
| Hollow glass beads | 560 |
| Properties | |
| Density (g/mL) | 0.7708 |
| Hardness, Shore D | 80.0 |

### EXAMPLES 32-53, COMPARATIVE EXAMPLES 15-19

These examples illustrate variations in the solubility of poly(arylene ether)s in styrenic monomers as a function of poly(arylene ether) structure and styrenic monomer structure. For each example, a solution was prepared by combining a poly(arylene ether) and a styrenic monomer and heating the mixture to 60° C. with agitation to dissolve the poly(arylene ether). The resulting solution was cooled to 23° C. If the mixture remained homogeneous by visual inspection (that is, no precipitate or turbidity was observed), the composition was characterized as “initially soluble at 23° C.”. Viscosity values were determined for the freshly prepared compositions. The mixture was left at 23° C. for seven days. If the mixture still appeared homogeneous by visual inspection, the composition was characterized as “soluble after 7 days at 23° C.”. Compositions and properties are summarized in Table 7, where the term “vinyl toluene” refers to a mixture of 3-methylstyrene and 4-methylstyrene.

TABLE 7

| | C. Ex. 15 | C. Ex. 16 | C. Ex. 17 | C. Ex. 18 | C. Ex. 19 |
|---|---|---|---|---|---|
| Compositions | | | | | |
| PPE, monofunctional, | 3.69 | 5.60 | 7.54 | 9.52 | 11.54 |
| 0.12 dL/g | | | | | |
| PPE, bifunctional, | 0 | 0 | 0 | 0 | 0 |
| 0.09 dL/g | | | | | |
| Styrene | 35.51 | 33.77 | 32.00 | 30.21 | 28.40 |
| Vinyl toluene | 0 | 0 | 0 | 0 | 0 |
| 4-t-Butylstyrene | 0 | 0 | 0 | 0 | 0 |
| Weight % PPE (%) | 10 | 15 | 20 | 25 | 30 |
| Properties | | | | | |
| Initially soluble at | yes | yes | yes | yes | yes |
| 23° C.? | | | | | |
| Soluble after 7 days at | yes | yes | no | no | no |
| 23° C.? | | | | | |
| Viscosity (cps) | 0 | 0 | 425 | 5270 | 0 |

| | Ex. 32 | Ex. 33 | Ex. 34 | Ex. 35 | Ex. 36 | Ex. 37 | Ex. 38 | Ex. 39 | Ex. 40 | Ex. 41 | Ex. 42 |
|---|---|---|---|---|---|---|---|---|---|---|---|
| Compositions | | | | | | | | | | | |
| PPE, | 0 | 0 | 0 | 0 | 0 | 0 | 0 | 0 | 0 | 0 | 0 |
| monofunctional, | | | | | | | | | | | |
| 0.12 dL/g | | | | | | | | | | | |
| PPE, bifunctional, | 3.69 | 5.60 | 7.54 | 9.52 | 11.54 | 13.61 | 15.72 | 17.87 | 20.07 | 22.32 | 24.61 |
| 0.09 dL/g | | | | | | | | | | | |
| Styrene | 0 | 0 | 0 | 0 | 0 | 0 | 0 | 0 | 0 | 0 | 0 |
| Vinyl toluene | 35.51 | 33.77 | 32.00 | 30.21 | 28.40 | 26.56 | 24.69 | 22.79 | 20.87 | 18.92 | 16.94 |
| 4-t-Butylstyrene | 0 | 0 | 0 | 0 | 0 | 0 | 0 | 0 | 0 | 0 | 0 |
| Weight % PPE (%) | 10 | 15 | 20 | 25 | 30 | 35 | 40 | 45 | 50 | 55 | 60 |
| Properties | | | | | | | | | | | |
| Initially soluble at | yes | yes | yes | yes | yes | yes | yes | yes | yes | yes | yes |
| 23° C.? | | | | | | | | | | | |
| Soluble after 7 days | yes | yes | yes | yes | yes | yes | yes | yes | yes | yes | yes |
| at 23° C.? | | | | | | | | | | | |
| Viscosity (cps) | — | — | — | — | 83 | 124 | 193 | 304 | 471 | — | — |
| | Ex. 43 | Ex. 44 | Ex. 45 | Ex. 46 | Ex. 47 | Ex. 48 | Ex. 49 | Ex. 50 | Ex. 51 | Ex. 52 | Ex. 53 |
| Compositions | | | | | | | | | | | |
| PPE, | 0 | 0 | 0 | 0 | 0 | 0 | 0 | 0 | 0 | 0 | 0 |
| monofunctional, | | | | | | | | | | | |
| 0.12 dL/g | | | | | | | | | | | |
| PPE, bifunctional, | 3.69 | 5.60 | 7.54 | 9.52 | 11.54 | 13.61 | 15.72 | 17.87 | 20.07 | 22.32 | 24.61 |
| 0.09 dL/g | | | | | | | | | | | |
| Styrene | 0 | 0 | 0 | 0 | 0 | 0 | 0 | 0 | 0 | 0 | 0 |
| Vinyl toluene | 0 | 0 | 0 | 0 | 0 | 0 | 0 | 0 | 0 | 0 | 0 |
| 4-t-Butylstyrene | 35.51 | 33.77 | 32.00 | 30.21 | 28.40 | 26.56 | 24.69 | 22.79 | 20.87 | 18.92 | 16.94 |
| Weight % PPE (%) | 10 | 15 | 20 | 25 | 30 | 35 | 40 | 45 | 50 | 55 | 60 |
| Properties | | | | | | | | | | | |
| Initially soluble at | yes | yes | yes | yes | yes | yes | yes | yes | yes | yes | yes |
| 23° C.? | | | | | | | | | | | |
| Soluble after 7 days | yes | yes | yes | yes | yes | yes | yes | yes | yes | yes | yes |
| at 23° C.? | | | | | | | | | | | |
| Viscosity (cps) | — | — | — | — | 85 | 128 | 210 | 334 | 521 | — | — |

### COMPARATIVE EXAMPLES 20-31

These comparative examples illustrate the viscosity of solutions of a bifunctional poly(arylene ether) (a methacrylate-capped copolymer of 2,6-dimethylphenol and 2,2-bis(3,5-dimethyl-4-hydroxy)propane having an intrinsic viscosity of 0.09 deciliter per gram in chloroform at 25° C.) in triallyl isocyanurate as a function of bifunctional poly(arylene ether) concentration and temperature. Viscosities were measured on a Brookfield viscometer and are expressed in centipoise (cps). Results are presented in Table 8, where the bifunctional poly(arylene ether) concentration is expressed in weight percent (“wt %”) based on the total weight of the solution.

TABLE 8

| | wt % PPE 0.09 | | |
|---|---|---|---|
| | bifxl. | Temperature (° C.) | Viscosity (cps) |
| C. Ex. 20 | 0 | 25.5 | 118 |
| C. Ex. 21 | 9 | 25.5 | 561 |
| C. Ex. 22 | 20 | 25.5 | 6,300 |
| C. Ex. 23 | 30 | 25.5 | 15,200 |
| C. Ex. 24 | 35 | 25.5 | 24,400 |
| C. Ex. 25 | 0 | 50.5 | 29 |
| C. Ex. 26 | 9 | 50.5 | 103.2 |
| C. Ex. 27 | 20 | 50.5 | 370.8 |
| C. Ex. 28 | 30 | 50.5 | 1080 |
| C. Ex. 29 | 35 | 50.5 | 2990 |
| C. Ex. 30 | 40 | 50.5 | 7120 |
| C. Ex. 24 | 45 | 50.5 | 12,340 |

Comparison of Comparative Examples 15-19 with Examples 19-29 shows that the bifunctional poly(arylene ether) having an intrinsic viscosity of 0.09 dL/g has substantially greater solubility in styrene monomer than the monofunctional poly(arylene ether having an intrinsic viscosity of 0.12 dL/g. Examples 32-53 show that the bifunctional poly(arylene ether) having an intrinsic viscosity of 0.09 dL/g has high solubility in vinyl toluene and t-butylstyrene monomers.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A cured composition, comprising a reaction product obtained on curing a curable composition, wherein the curable composition comprises:
a bifunctional poly(arylene ether) having an intrinsic viscosity of about 0.03 to about 0.2 deciliter per gram, measured in chloroform at 25° C.; and
an alkyl styrene having the structure 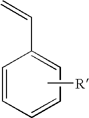
wherein R′ is C₁-C₆ primary or tertiary alkyl;
wherein the bifunctional poly(arylene ether) has a solubility in the alkyl styrene of at least 10 weight percent for at least seven days at 23° C., wherein the weight percent is based on the total weight of the bifunctional poly(arylene ether) and the alkyl styrene; and
wherein the curable composition has a viscosity less than or equal to 2000 centipoise at 23° C.

2. The cured composition of claim 1, wherein the bifunctional poly(arylene ether) has a solubility in the alkyl styrene of 10 to about 80 weight percent for seven days at 23° C.

3. The cured composition of claim 1, wherein the bifunctional poly(arylene ether) has a solubility in the alkyl styrene of about 20 to about 70 weight percent for seven days at 23° C.

4. The cured composition of claim 1, wherein the bifunctional poly(arylene ether) has a solubility in the alkyl styrene of about 30 to about 60 weight percent for seven days at 23° C.

5. The cured composition of claim 1, wherein the curable composition has a viscosity of about 10 to 2000 centipoise at 23° C.

6. The cured composition of claim 1, wherein the curable composition has a viscosity of about 20 to about 1000 centipoise at 23° C.

7. The cured composition of claim 1, wherein the curable composition has a viscosity of about 50 to about 600 centipoise at 23° C.

8. The cured composition of claim 1, wherein the bifunctional poly(arylene ether) has an intrinsic viscosity of about 0.03 to about 0.12 deciliter per gram.

9. The cured composition of claim 1, wherein the bifunctional poly(arylene ether) has an intrinsic viscosity of about 0.06 deciliter per gram.

10. The cured composition of claim 1, wherein the bifunctional poly(arylene ether) has an intrinsic viscosity of about 0.09 deciliter per gram.

11. The cured composition of claim 1, wherein the bifunctional poly(arylene ether) has the structure 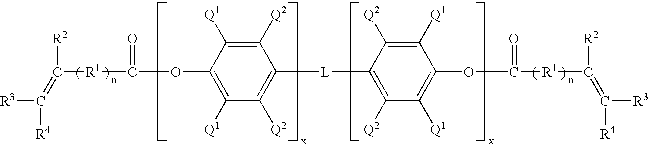
wherein each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of x is independently 1 to about 100; each occurrence of R¹ is independently C₁-C₁₂ hydrocarbylene; each occurrence of n is independently 0 or 1; each occurrence of R²-R⁴ is independently hydrogen or C₁-C₁₈ hydrocarbyl; and L has the structure 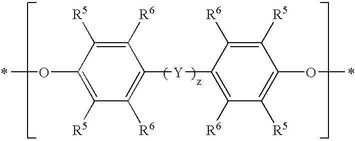
wherein each occurrence of R⁵ and R⁶ is independently selected from the group consisting of hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y has a structure selected from the group consisting of 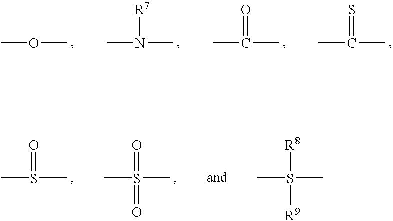
wherein each occurrence of R⁷ is independently selected from the group consisting of hydrogen and C₁-C₁₂ hydrocarbyl, and each occurrence of R⁸ and R⁹ is independently selected from the group consisting of hydrogen, C₁-C₁₂ hydrocarbyl, and C₁-C₆ hydrocarbylene wherein R⁸ and R⁹ collectively form a C₄-C₁₂ alkylene group.

12. The cured composition of claim 1, wherein the bifunctional poly(arylene ether) has the structure 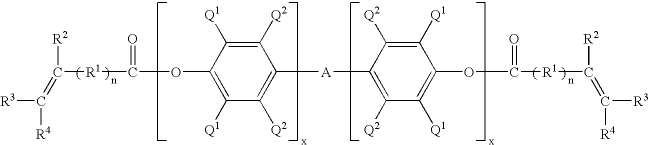
wherein each occurrence of Q¹ is independently halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of x is independently 1 to about 100; each occurrence of R¹ is independently C₁-C₁₂ hydrocarbylene; each occurrence of n is independently 0 or 1; each occurrence of R² and R³ and R⁴ is independently hydrogen or C₁-C₁₈ hydrocarbyl; and A has the structure 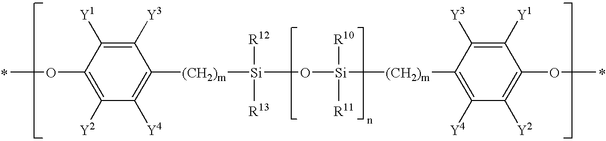
wherein each occurrence of R¹⁰ and R¹¹ and R¹² and R¹³ is independently hydrogen, C₁-C₁₂ hydrocarbyl or C₁-C₁₂ halohydrocarbyl; wherein each occurrence of m is independently 0, 1, 2, 3, 4, 5, or 6; and wherein each occurrence of Y¹ and Y² and Y³ and Y⁴ is independently hydrogen, C₁-C₁₂ hydrocarbyl, C₁-C₁₂ hydrocarbyloxy, or halogen; and wherein n is 5 to about 200.

13. The cured composition of claim 1, wherein the bifunctional poly(arylene ether) has the structure 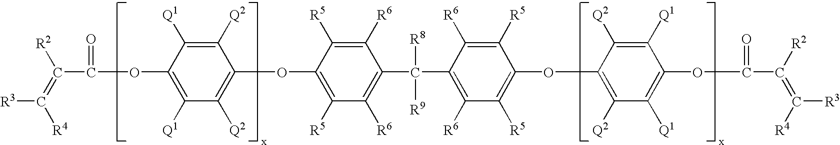
wherein Q¹ is methyl; each occurrence of Q² is independently hydrogen or methyl; each occurrence of R² is independently hydrogen or methyl; R³ and R⁴ are hydrogen; each occurrence of R⁵ and R⁶ is independently selected from the group consisting of hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; each occurrence of R⁸ and R⁹ is independently selected from the group consisting of hydrogen, C₁-C₁₂ hydrocarbyl, and C₁-C₆ hydrocarbylene wherein R⁸ and R⁹ collectively form a C₄-C₁₂ alkylene group; and each occurrence of x is independently 1 to about 50.

14. The cured composition of claim 1, wherein the bifunctional poly(arylene ether) has the structure 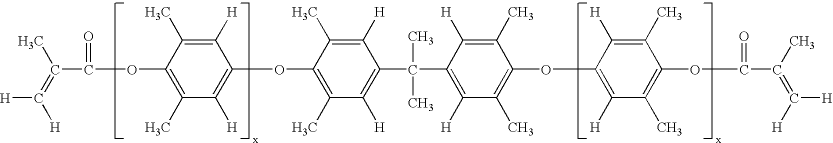
wherein each occurrence of x is independently 1 to about 20.

15. The cured composition of claim 1, wherein the bifunctional poly(arylene ether) is produced by a process comprising oxidative copolymerization of a monohydric phenol and a dihydric phenol.

16. The cured composition of claim 15, wherein the monohydric phenol is selected from the group consisting of 2,6-dimethylphenol, 2,3,6-trimethylphenol, and mixtures thereof; and wherein the dihydric phenol is selected from the group consisting of 3,3′,5,5′-tetramethyl-4,4′-biphenol, 2,2-bis(3-methyl-4-hydroxyphenyl)propane, 2,2-bis(3,5-dimethyl-4-hydroxyphenyl)propane, 1,1-bis(4-hydroxyphenyl)methane, 1,1-bis(4-hydroxyphenyl)ethane, 2,2-bis(4-hydroxyphenyl)propane 2,2-bis(4-hydroxyphenyl)butane, 2,2-bis(4-hydroxyphenyl)octane, 1,1-bis(4-hydroxyphenyl)propane, 1,1-bis(4-hydroxyphenyl)-n-butane, bis(4-hydroxyphenyl)phenylmethane, 1,1-bis(4-hydroxy-3-methylphenyl)cyclohexane, 1,1-bis(4-hydroxy-3,5-dimethylphenyl)cyclopentane, 1,1-bis(4-hydroxy-3,5-dimethylphenyl)cyclohexane, 1,1-bis(4-hydroxy-3-methylphenyl)cycloheptane, 1,1-bis(4-hydroxy-3,5-dimethylphenyl)cycloheptane, 1,1-bis(4-hydroxy-3-methylphenyl)cyclooctane, 1,1-bis(4-hydroxy-3,5-dimethylphenyl)cyclooctane, 1,1-bis(4-hydroxy-3-methylphenyl)cyclononane, 11,1-bis(4-hydroxy-3,5-dimethylphenyl)cyclononane, 1,1-bis(4-hydroxy-3-methylphenyl)cyclodecane, 1,1-bis(4-hydroxy-3,5-dimethylphenyl)cyclodecane, 1,1-bis(4-hydroxy-3-methylphenyl)cycloundecane, 1,1-bis(4-hydroxy-3,5-dimethylphenyl)cycloundecane, 1,1-bis(4-hydroxy-3-methylphenyl)cyclododecane, 1,1-bis(4-hydroxy-3,5-dimethylphenyl)cyclododecane, 1,1-bis(4-hydroxy-3-t-butylphenyl)propane, 2,2-bis(4-hydroxy-2,6-dimethylphenyl)propane 2,2-bis(4-hydroxy-3-bromophenyl)propane, 1,1-bis(4-hydroxyphenyl)cyclopentane, 1,1-bis(4-hydroxyphenyl)cyclohexane, and mixtures thereof.

17. The cured composition of claim 15, wherein the monohydric phenol is 2,6-dimethylphenol, and wherein the dihydric phenol is 2,2-bis(3,5-dimethyl-4-hydroxyphenyl)propane.

18. The cured composition of claim 15, wherein the monohydric phenol is 2,6-dimethylphenol, and wherein the dihydric phenol is selected from the group consisting of 2,2-bis(3-methyl-4-hydroxyphenyl)propane, 1,1-bis(4-hydroxy-3-methylphenyl)cyclohexane, 1,1-bis(4-hydroxy-3,5-dimethylphenyl)cyclohexane, and mixtures thereof.

19. The cured composition of claim 1, wherein the alkyl styrene is selected from the group consisting of 3-methylstyrene, 4-methylstyrene, 3-tert-butylstyrene, 4-tert-butylstyrene, and mixtures thereof.

20. The cured composition of claim 1, wherein the alkyl styrene is selected from the group consisting of 3-methylstyrene, 4-methylstyrene, and mixtures thereof.

21. The cured composition of claim 1, wherein the alkyl styrene is 4-methylstyrene.

22. The cured composition of claim 1, wherein the alkyl styrene is selected from the group consisting of 3-tert-butylstyrene, 4-tert-butylstyrene, and mixtures thereof.

23. The cured composition of claim 1, wherein the alkyl styrene is 4-tert-butylstyrene.

24. The cured composition of claim 1, wherein the curable composition further comprises styrene.

25. The cured composition of claim 1, wherein the curable composition further comprises a crosslinker selected from the group consisting of divinylbenzenes, diallylbezenes, trivinylbenzenes, triallylbenzenes, divinyl phthalates, diallyl phthalates, triallyl mesate, triallyl mesitate, triallyl cyanurate, triallyl isocyanurate, trimethylolpropane tri(meth)acrylate, 1,6-hexanediol di(meth)acrylate, neopentyl glycol di(meth)acrylate, dipropylene glycol di(meth)acrylate, ethylene glycol di(meth)acrylate, propylene glycol di(meth)acrylate, cyclohexanedimethanol di(meth)acrylate, butanediol di(meth)acrylate, diethylene glycol di(meth)acrylate, triethylene glycol di(meth)acrylate, isobornyl(meth)acrylate, methyl(meth)acrylate, methacryloxypropyl trimethoxysilane, bisphenol A dimethacrylate, (ethoxylated)₁₋₂₀ nonylphenol (meth)acrylates, (propoxylated)₁₋₂₀ nonylphenol (meth)acrylates, (ethoxylated)₁₋₂₀ tetrahydrofurfuryl(meth)acrylates, (propoxylated)₁₋₂₀ tetrahydrofurfuryl(meth)acrylates, (ethoxylated)₁₋₂₀ hydroxyethyl(meth)acrylates, (propoxylated)₁₋₂₀ hydroxyethyl(meth)acrylates, (ethoxylated)₂₋₄₀ 1,6-hexanediol di(meth)acrylates, (propoxylated)₂₋₄₀ 1,6-hexanediol di(meth)acrylates, (ethoxylated)₂₋₄₀ 1,4-butanediol di(meth)acrylates, (propoxylated)₂₋₄₀ 1,4-butanediol di(meth)acrylates, (ethoxylated)₂₋₄₀ 1,3-butanediol di(meth)acrylates, (propoxylated)₂₋₄₀ 1,3-butanediol di(meth)acrylates, (ethoxylated)₂₋₄₀ ethylene glycol di(meth)acrylates, (propoxylated)₂₋₄₀ ethylene glycol di(meth)acrylates, (ethoxylated)₂₋₄₀ propylene glycol di(meth)acrylates, (propoxylated)₂₋₄₀ propylene glycol di(meth)acrylates, (ethoxylated)₂₋₄₀ 1,4-cyclohexanedimethanol di(meth)acrylates, (propoxylated)₂₋₄₀ 1,4-cyclohexanedimethanol di(meth)acrylates, (ethoxylated)₂₋₄₀ bisphenol-A di(meth)acrylates, (propoxylated)₂₋₄₀ bisphenol-A di(meth)acrylates, (ethoxylated)₃₋₆₀ glycerol tri(meth)acrylates, (propoxylated)₃₋₆₀ glycerol tri(meth)acrylates, (ethoxylated)₃₋₆₀ trimethylolpropane tri(meth)acrylates, (propoxylated)₃₋₆₀ trimethylolpropane tri(meth)acrylates, (ethoxylated)₃₋₆₀ isocyanurate tri(meth)acrylates, (propoxylated)₃₋₆₀ isocyanurate tri(meth)acrylates, (ethoxylated)₄₋₈₀ pentaerythritol tetra(meth)acrylates, (propoxylated)₄₋₈₀ pentaerythritol tetra(meth)acrylates, (ethoxylated)₆₋₁₂₀ dipentaerythritol tetra(meth)acrylates, (propoxylated)₆₋₁₂₀ dipentaerythritol tetra(meth)acrylates, and mixtures thereof.

26. The cured composition of claim 1, wherein the curable composition further comprises a divinylbenzene.

27. The cured composition of claim 1, wherein the curable composition further comprises a curing initiator, a curing inhibitor, or a combination thereof.

28. The cured composition of claim 1, wherein the cured composition is partially cured.

29. A cured composition, consisting of the reaction product obtained on curing a curable composition consisting of:
a bifunctional poly(arylene ether) having an intrinsic viscosity of about 0.03 to about 0.2 deciliter per gram, measured in chloroform at 25° C.;
an alkyl styrene having the structure 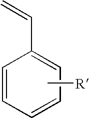
wherein R′ is C₁-C₆ primary or tertiary alkyl;
optionally, a filler;
optionally, a crosslinker selected from the group consisting of divinylbenzenes, diallylbenzenes, trivinylbenzenes, triallylbenzenes, divinyl phthalates, diallyl phthalates, triallyl mesate, triallyl mesitate, ethoxylated bisphenol A dimethacrylates, and mixtures thereof;
optionally, a curing initiator, a curing inhibitor, or a combination thereof; and
optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof;
wherein the bifunctional poly(arylene ether) has a solubility in the alkyl styrene of at least 10 weight percent for at least seven days at 23° C.; and
wherein the curable composition in the absence of optional filler has a viscosity less than or equal to 2000 centipoise at 23° C.

30. A cured composition, comprising a reaction product obtained on curing a curable composition, wherein the curable composition comprises:
about 30 to about 90 parts by weight of a bifunctional poly(arylene ether) having an intrinsic viscosity of about 0.03 to about 0.2 deciliter per gram, measured in chloroform at 25° C., wherein the bifunctional poly(arylene ether) has the structure 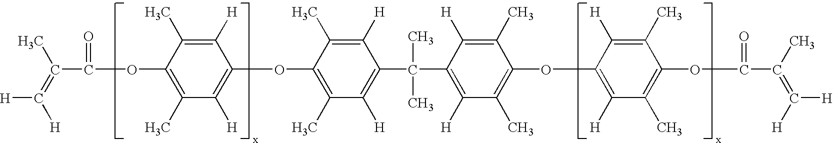
wherein each occurrence of x is independently 1 to about 20; and
about 10 to about 70 parts by weight of an alkyl styrene selected from the group consisting of 2-methylstyrene, 4-methylstyrene, 2-tert-butylstyrene, 4-tert-butylstyrene, and mixtures thereof;
wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene; and
wherein the curable composition has a viscosity of about 50 to about 600 centipoise at 23° C.;
wherein all parts by weight are based on 100 parts by weight total of the bifunctional poly(arylene ether) and the alkyl styrene.

31. A cured composition, consisting of the reaction product obtained on curing a curable composition consisting of:
about 30 to about 90 parts by weight of a bifunctional poly(arylene ether) having an intrinsic viscosity of about 0.03 to about 0.2 deciliter per gram, measured in chloroform at 25° C., wherein the bifunctional poly(arylene ether) has the structure 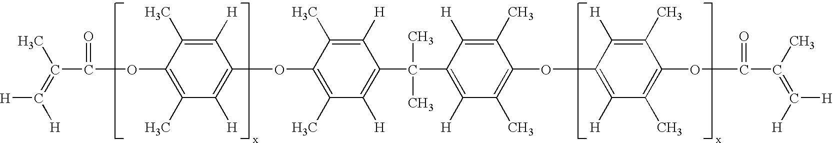
wherein each occurrence of x is independently 1 to about 20; and
about 10 to about 70 parts by weight of an alkyl styrene selected from the group consisting of 2-methylstyrene, 4-methylstyrene, 2-tert-butylstyrene, 4-tert-butylstyrene, and mixtures thereof;
optionally, about 2 to about 95 weight percent of a filler, based on the total weight of the composition;
optionally, about 4 to about 16 parts by weight of divinylbenzene;
optionally, a curing initiator, a curing inhibitor, or a combination thereof; and
optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof;
wherein all parts by weight are based on 100 parts by weight total of the bifunctional poly(arylene ether) and the alkyl styrene; and
wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene;
wherein the curable composition in the absence of optional filler has a viscosity of about 50 to about 600 centipoise at 23° C.

32. A cured composition, comprising a reaction product obtained on curing a curable composition, wherein the curable composition comprises:
about 40 to about 80 parts by weight of a bifunctional poly(arylene ether) having an intrinsic viscosity of about 0.03 to about 0.12 deciliter per gram, measured in chloroform at 25° C., wherein the bifunctional poly(arylene ether) has the structure 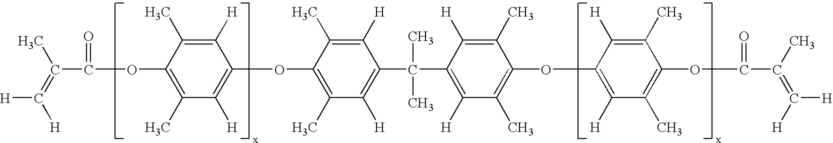
wherein each occurrence of x is independently 1 to about 20; and
about 20 to about 60 parts by weight of an alkyl styrene selected from the group consisting of 2-methylstyrene, 4-methylstyrene, 2-tert-butylstyrene, 4-tert-butylstyrene, and mixtures thereof;
wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene; and
wherein the curable composition has a viscosity of about 50 to about 600 centipoise at 23° C.;
wherein all parts by weight are based on 100 parts by weight total of the bifunctional poly(arylene ether) and the alkyl styrene.

33. A cured composition, consisting of a reaction product obtained on curing a curable composition, wherein the curable composition consists of:
about 40 to about 80 parts by weight of a bifunctional poly(arylene ether) having an intrinsic viscosity of about 0.03 to about 0.12 deciliter per gram, measured in chloroform at 25° C., wherein the bifunctional poly(arylene ether) has the structure 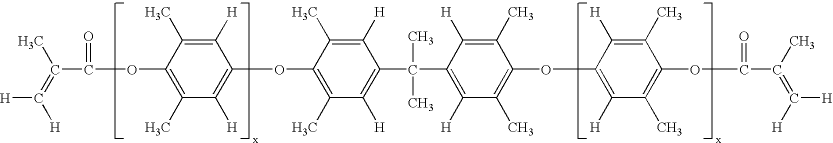
wherein each occurrence of x is independently 1 to about 20; and
about 20 to about 60 parts by weight of an alkyl styrene selected from the group consisting of 2-methylstyrene, 4-methylstyrene, 2-tert-butylstyrene, 4-tert-butylstyrene, and mixtures thereof;
optionally, about 2 to about 95 weight percent of a filler, based on the total weight of the composition;
optionally, about 4 to about 16 parts by weight of divinylbenzene;
optionally, a curing initiator, a curing inhibitor, or a combination thereof; and
optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof;
wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene; and
wherein the curable composition has a viscosity of about 50 to about 600 centipoise at 23° C.;
wherein all parts by weight are based on 100 parts by weight total of the bifunctional poly(arylene ether) and the alkyl styrene.

34. A cured composition, comprising a reaction product obtained on curing a curable composition, wherein the curable composition comprises:
about 50 to about 70 parts by weight of a bifunctional poly(arylene ether) having an intrinsic viscosity of about 0.06 to about 0.12 deciliter per gram, measured in chloroform at 25° C., wherein the bifunctional poly(arylene ether) has the structure 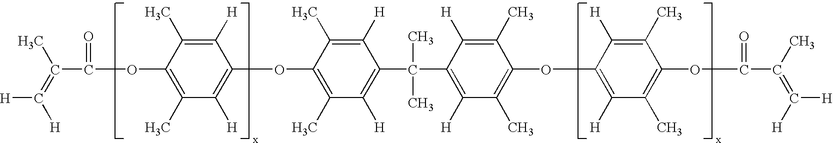
wherein each occurrence of x is independently 1 to about 20; and
about 30 to about 50 parts by weight of an alkyl styrene selected from the group consisting of 2-methylstyrene, 4-methylstyrene, 2-tert-butylstyrene, 4-tert-butylstyrene, and mixtures thereof;
wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene; and
wherein the curable composition has a viscosity of about 50 to about 600 centipoise at 23° C.;
wherein all parts by weight are based on 100 parts by weight total of the bifunctional poly(arylene ether) and the alkyl styrene.

35. A cured composition, consisting of the reaction product obtained on curing a curable composition consisting of:
about 50 to about 70 parts by weight of a bifunctional poly(arylene ether) having an intrinsic viscosity of about 0.06 to about 0.12 deciliter per gram, measured in chloroform at 25° C., wherein the bifunctional poly(arylene ether) has the structure 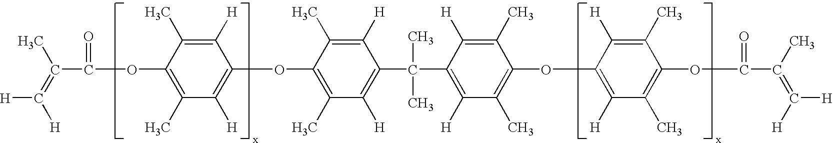
wherein each occurrence of x is independently 1 to about 20;
about 30 to about 60 parts by weight of an alkyl styrene selected from the group consisting of 2-methylstyrene, 4-methylstyrene, 2-tert-butylstyrene, 4-tert-butylstyrene, and mixtures thereof;
optionally, about 2 to about 95 weight percent of a filler, based on the total weight of the composition;
optionally, about 4 to about 16 parts by weight of divinylbenzene;
optionally, a curing initiator, a curing inhibitor, or a combination thereof; and
optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof;
wherein the bifunctional poly(arylene ether) has a solubility in the alkyl styrene of about 30 to about 60 weight percent for seven days at 23° C., wherein the weight percent is based on the total weight of the bifunctional poly(arylene ether) and the alkyl styrene; and
wherein the curable composition has a viscosity of about 50 to about 600 centipoise at 23° C.;
wherein all parts by weight are based on 100 parts by weight total of the bifunctional poly(arylene ether) and the alkyl styrene.

36. A syntactic foam, comprising a reaction product obtained on curing a curable composition, wherein the curable composition comprises:
a bifunctional poly(arylene ether) having an intrinsic viscosity of about 0.03 to about 0.2 deciliter per gram, measured in chloroform at 25° C.;
an alkyl styrene having the structure 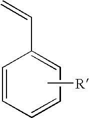
wherein R′is C₁-C₆ primary or tertiary alkyl; and
glass beads having a density less than or equal to 0.5 gram per milliliter and an isostatic crush strength of at least 10 megapascals, wherein 95 volume percent of beads have a diameter less than or equal to 200 micrometers;
wherein the bifunctional poly(arylene ether) has a solubility in the alkyl styrene of at least 10 weight percent for seven days at 23° C., wherein the weight percent is based on the total weight of the bifunctional poly(arylene ether) and the alkyl styrene; and
wherein the curable composition in the absence of the glass beads has a viscosity less than or equal to 2000 centipoise at 23° C.; and
wherein the composition after curing has a density less than or equal to 0.9 gram per milliliter at 23° C.

37. An article comprising the cured composition of claim 1.

38. An article comprising the cured composition of claim 29.

39. An article comprising the cured composition of claim 30.

40. An article comprising the cured composition of claim 31.

41. An article comprising the cured composition of claim 32.

42. An article comprising the cured composition of claim 33.

43. An article comprising the cured composition of claim 34.

44. An article comprising the cured composition of claim 35.

45. An article comprising the syntactic foam of claim 36.
